(19) United States
(12) Patent Application Publication
(10) Pub. No.: US 2019/0042977 A1
(43) Pub. Date: Feb. 7, 2019

(54) BANDWIDTH SELECTION IN SUPPORT VECTOR DATA DESCRIPTION FOR OUTLIER IDENTIFICATION

(71) Applicant: SAS Institute Inc., Cary, NC (US)

(72) Inventors: Arin Chaudhuri, Raleigh, NC (US); Deovrat Vijay Kakde, Cary, NC (US); Carol Wagih Sadek, Chapel Hill, NC (US); Seung Hyun Kong, Cary, NC (US); Laura Lucia Gonzalez, Raleigh, NC (US)

(21) Appl. No.: 15/887,037

(22) Filed: Feb. 2, 2018

Related U.S. Application Data
(60) Provisional application No. 62/542,006, filed on Aug. 7, 2017.
(60) Provisional application No. 62/544,879, filed on Aug. 13, 2017.

(51) Int. Cl. G06N 99/00; G06N 5/02

(52) U.S. Cl. CPC G06N 99/005; G06F 17/12; G06N 5/022

(57) ABSTRACT

A computing device employs machine learning and determines a bandwidth parameter value for a support vector data description (SVDD). A mean pairwise distance value is computed between observation vectors. A scaling factor value is computed based on a number of the plurality of observation vectors and a predefined tolerance value. A Gaussian bandwidth parameter value is computed using the computed mean pairwise distance value and the computed scaling factor value. An optimal value of an objective function is computed that includes a Gaussian kernel function that uses the computed Gaussian bandwidth parameter value. The objective function defines a SVDD model using the plurality of observation vectors to define a set of support vectors. The computed Gaussian bandwidth parameter value and the defined a set of support vectors are output for determining if a new observation vector is an outlier.

### CROSS-REFERENCE TO RELATED APPLICATIONS

The present application claims the benefit of 35 U.S.C. § 119(e) to U.S. Provisional Patent Application No. 62/542,006 filed on Aug. 7, 2017, the entire contents of which are hereby incorporated by reference. The present application also claims the benefit of 35 U.S.C. § 119(e) to U.S. Provisional Patent Application No. 62/544,879 filed on Aug. 13, 2017, the entire contents of which are hereby incorporated by reference.

### BACKGROUND

Support vector data description (SVDD) is a machine-learning technique used for single class classification and outlier or anomaly detection. The SVDD classier partitions the whole space into an inlier region which consists of the region near the training data, and an outlier region which consists of points away from the training data. The computation of the SVDD classifier uses a kernel function with the Gaussian kernel being a common choice for the kernel function. The Gaussian kernel has a bandwidth parameter, and it is important to set the value of this parameter correctly for good results. A small bandwidth leads to over-fitting and the resulting SVDD classifier overestimates the number of anomalies, while a large bandwidth leads to under-fitting and the resulting SVDD classifier underestimates the number of anomalies resulting in possibly many anomalies or outliers not being detected by the classifier.

### SUMMARY

In an example embodiment, a non-transitory computer-readable medium is provided having stored thereon computer-readable instructions that, when executed by a computing device, cause the computing device to determine a bandwidth parameter value for a support vector data description for outlier identification. A mean pairwise distance value is computed between a plurality of observation vectors, wherein each observation vector of the plurality of observation vectors includes a variable value for each variable of a plurality of variables. A scaling factor value is computed based on a number of the plurality of observation vectors and a predefined tolerance value. A Gaussian bandwidth parameter value is computed using the computed mean pairwise distance value and the computed scaling factor value. An optimal value of an objective function is computed that includes a Gaussian kernel function that uses the computed Gaussian bandwidth parameter value. The objective function defines a support vector data description (SVDD) model using the plurality of observation vectors to define a set of support vectors. The computed Gaussian bandwidth parameter value and the defined a set of support vectors are output for determining if a new observation vector is an outlier.

In another example embodiment, a computing device is provided. The computing device includes, but is not limited to, a processor and a non-transitory computer-readable medium operably coupled to the processor. The computer-readable medium has instructions stored thereon that, when executed by the computing device, cause the computing device to determine a bandwidth parameter value for a support vector data description for outlier identification.

In yet another example embodiment, a method of determining a bandwidth parameter value for a support vector data description for outlier identification is provided.

Other principal features of the disclosed subject matter will become apparent to those skilled in the art upon review of the following drawings, the detailed description, and the appended claims.

### BRIEF DESCRIPTION OF THE DRAWINGS

Illustrative embodiments of the disclosed subject matter will hereafter be described referring to the accompanying drawings, wherein like numerals denote like elements.

FIG. 1 depicts a block diagram of a support vector data description (SVDD) training device in accordance with an illustrative embodiment.

FIG. 2 depicts an SVDD result defining a normal data description in accordance with an illustrative embodiment.

FIG. 3 depicts an SVDD result defining a flexible data description using a Gaussian kernel function in accordance with an illustrative embodiment.

FIG. 4 depicts a flow diagram illustrating examples of operations performed by the SVDD training device of FIG. 1 in accordance with an illustrative embodiment.

FIG. 5 depicts a first sample dataset having a banana shape in accordance with an illustrative embodiment.

FIGS. 6A to 6D depict SVDD scoring results using Gaussian bandwidth parameter values computed using four different methods and the first sample dataset of FIG. 5 in accordance with an illustrative embodiment.

FIG. 7 depicts a second sample dataset having a star shape in accordance with an illustrative embodiment.

FIGS. 8A to 8D depict SVDD scoring results using Gaussian bandwidth parameter values computed using the four different methods and the second sample dataset of FIG. 7 in accordance with an illustrative embodiment.

FIG. 9 depicts a third sample dataset having a three-cluster shape in accordance with an illustrative embodiment.

FIG. 10 depicts a pairwise distance histogram of the third sample dataset in accordance with an illustrative embodiment.

FIGS. 11A to 11D depict SVDD scoring results using Gaussian bandwidth parameter values computed using the four different methods and the third sample dataset of FIG. 9 in accordance with an illustrative embodiment.

FIG. 12 depicts a fourth sample dataset of refrigerant pressure versus inlet water temperature in accordance with an illustrative embodiment.

FIG. 13 depicts a pairwise distance histogram of the fourth sample dataset in accordance with an illustrative embodiment.

FIGS. 14A to 14D depict SVDD scoring results using Gaussian bandwidth parameter values computed using the four different methods and the fourth sample dataset of FIG. 12 in accordance with an illustrative embodiment.

FIG. 15 depicts a fifth sample dataset having a two-donut and a small oval shape in accordance with an illustrative embodiment.

FIG. 16 depicts a pairwise distance histogram of the fifth sample dataset in accordance with an illustrative embodiment.

FIGS. 17A to 17D depict SVDD scoring results using Gaussian bandwidth parameter values computed using the four different methods and the fifth sample dataset of FIG. 15 in accordance with an illustrative embodiment.

FIG. 18 depicts a block diagram of an outlier identification device in accordance with an illustrative embodiment.

FIG. 19 depicts a flow diagram illustrating examples of operations performed by the outlier identification device of FIG. 18 in accordance with an illustrative embodiment.

### DETAILED DESCRIPTION

Support vector data description (SVDD) like other one class classifiers provides a geometric description of observed data. The SVDD classifier computes a distance to each point in the domain space which is a measure of the separation of that point from the training data. During scoring, if an observation is found to be a large distance from the training data, it may be an anomaly, and the user may choose to generate an alert that a system or a device is not performing as expected or a detrimental event has occurred.

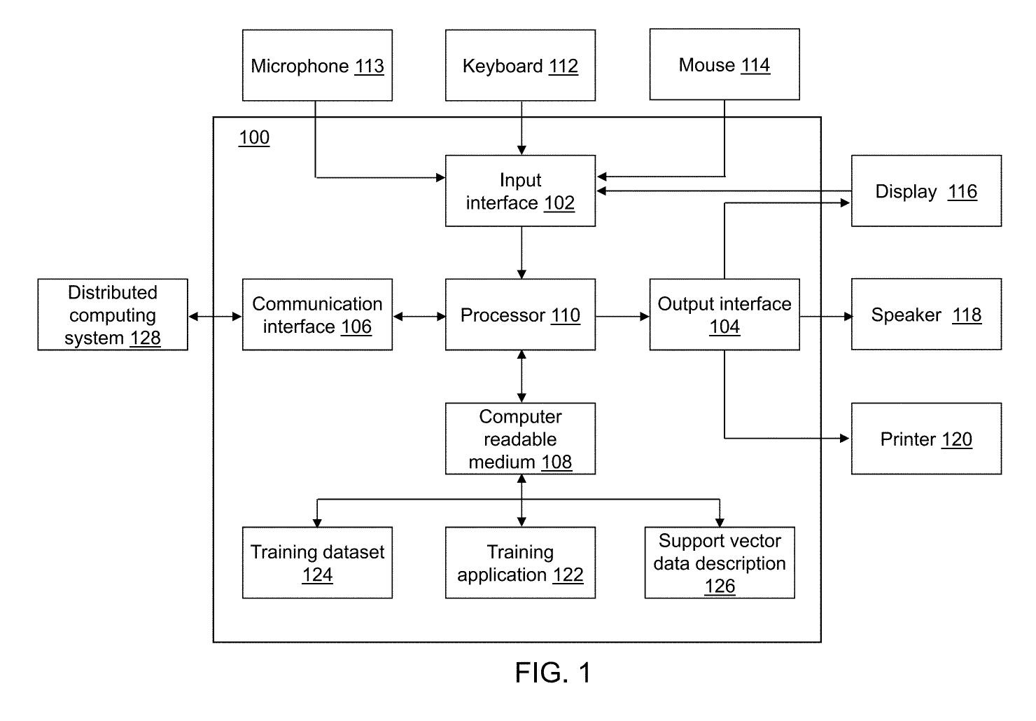

Referring to FIG. 1, a block diagram of a SVDD training device 100 is shown in accordance with an illustrative embodiment. SVDD training device 100 may include an input interface 102, an output interface 104, a communication interface 106, a non-transitory computer-readable medium 108, a processor 110, a training application 122, a training dataset 124, and a support vector data description (SVDD) 126. Fewer, different, and/or additional components may be incorporated into SVDD training device 100.

Input interface 102 provides an interface for receiving information from the user or another device for entry into SVDD training device 100 as understood by those skilled in the art. Input interface 102 may interface with various input technologies including, but not limited to, a keyboard 112, a microphone 113, a mouse 114, a display 116, a track ball, a keypad, one or more buttons, etc. to allow the user to enter information into SVDD training device 100 or to make selections presented in a user interface displayed on display 116. The same interface may support both input interface 102 and output interface 104. For example, display 116 comprising a touch screen provides a mechanism for user input and for presentation of output to the user. SVDD training device 100 may have one or more input interfaces that use the same or a different input interface technology. The input interface technology further may be accessible by SVDD training device 100 through communication interface 106.

Output interface 104 provides an interface for outputting information for review by a user of SVDD training device 100 and/or for use by another application or device. For example, output interface 104 may interface with various output technologies including, but not limited to, display 116, a speaker 118, a printer 120, etc. SVDD training device 100 may have one or more output interfaces that use the same or a different output interface technology. The output interface technology further may be accessible by SVDD training device 100 through communication interface 106.

Communication interface 106 provides an interface for receiving and transmitting data between devices using various protocols, transmission technologies, and media as understood by those skilled in the art. Communication interface 106 may support communication using various transmission media that may be wired and/or wireless. SVDD training device 100 may have one or more communication interfaces that use the same or a different communication interface technology. For example, SVDD training device 100 may support communication using an Ethernet port, a Bluetooth antenna, a telephone jack, a USB port, etc. Data and messages may be transferred between SVDD training device 100 and another computing device of a distributed computing system 128 using communication interface 106.

Computer-readable medium 108 is an electronic holding place or storage for information so the information can be accessed by processor 110 as understood by those skilled in the art. Computer-readable medium 108 can include, but is not limited to, any type of random access memory (RAM), any type of read only memory (ROM), any type of flash memory, etc. such as magnetic storage devices (e.g., hard disk, floppy disk, magnetic strips, . . . ), optical disks (e.g., compact disc (CD), digital versatile disc (DVD), . . . ), smart cards, flash memory devices, etc. SVDD training device 100 may have one or more computer-readable media that use the same or a different memory media technology. For example, computer-readable medium 108 may include different types of computer-readable media that may be organized hierarchically to provide efficient access to the data stored therein as understood by a person of skill in the art. As an example, a cache may be implemented in a smaller, faster memory that stores copies of data from the most frequently/recently accessed main memory locations to reduce an access latency. SVDD training device 100 also may have one or more drives that support the loading of a memory media such as a CD, DVD, an external hard drive, etc. One or more external hard drives further may be connected to SVDD training device 100 using communication interface 106.

Processor 110 executes instructions as understood by those skilled in the art. The instructions may be carried out by a special purpose computer, logic circuits, or hardware circuits. Processor 110 may be implemented in hardware and/or firmware. Processor 110 executes an instruction, meaning it performs/controls the operations called for by that instruction. The term “execution” is the process of running an application or the carrying out of the operation called for by an instruction. The instructions may be written using one or more programming language, scripting language, assembly language, etc. Processor 110 operably couples with input interface 102, with output interface 104, with communication interface 106, and with computer-readable medium 108 to receive, to send, and to process information. Processor 110 may retrieve a set of instructions from a permanent memory device and copy the instructions in an executable form to a temporary memory device that is generally some form of RAM. SVDD training device 100 may include a plurality of processors that use the same or a different processing technology.

Some machine-learning approaches may be more efficiently and speedily executed and processed with machine-learning specific processors (e.g., not a generic CPU). Such processors may also provide additional energy savings when compared to generic CPUs. For example, some of these processors can include a graphical processing unit (GPU), an application-specific integrated circuit (ASIC), a field-programmable gate array (FPGA), an artificial intelligence (AI) accelerator, a purpose-built chip architecture for machine learning, and/or some other machine-learning specific processor that implements a machine learning approach using semiconductor (e.g., silicon (Si), gallium arsenide (GaAs)) devices. These processors may also be employed in heterogeneous computing architectures with a number of and a variety of different types of cores, engines, nodes, and/or layers to achieve additional various energy efficiencies, processing speed improvements, data communication speed improvements, and/or data efficiency targets and improvements throughout various parts of the system.

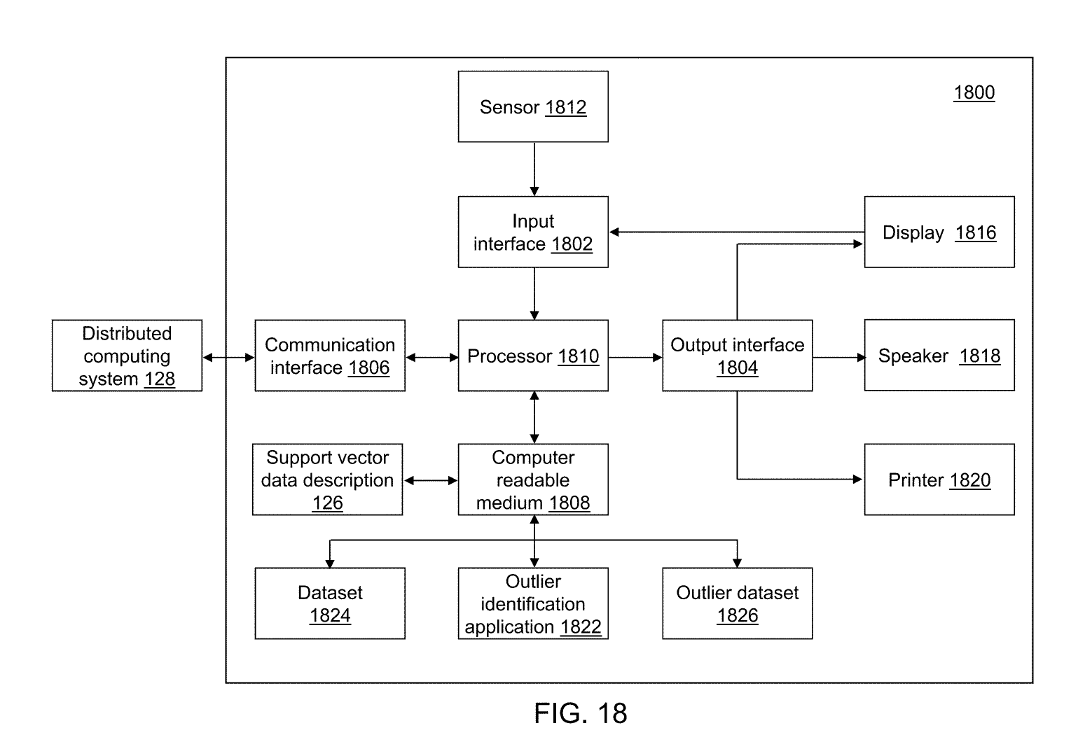

Training application 122 performs operations associated with computing a value for a Gaussian bandwidth parameter value s and defining SVDD 126 from data stored in training dataset 124. SVDD 126 may be used to classify data stored in a dataset 1824 (shown referring to FIG. 18) to determine when an observation vector in dataset 1824 is an outlier or otherwise anomalous vector of data that may be stored in an outlier dataset 1826 (shown referring to FIG. 18) to support various data analysis functions as well as provide alert/messaging related to monitored data. Some or all of the operations described herein may be embodied in training application 122. The operations may be implemented using hardware, firmware, software, or any combination of these methods.

Referring to the example embodiment of FIG. 1, training application 122 is implemented in software (comprised of computer-readable and/or computer-executable instructions) stored in computer-readable medium 108 and accessible by processor 110 for execution of the instructions that embody the operations of training application 122. Training application 122 may be written using one or more programming languages, assembly languages, scripting languages, etc. Training application 122 may be integrated with other analytic tools. As an example, training application 122 may be part of an integrated data analytics software application and/or software architecture such as that offered by SAS Institute Inc. of Cary, N.C., USA. For example, training application 122 may be implemented using or integrated with one or more SAS software tools such as SAS® Enterprise Miner™ Base SAS, SAS/STAT®, SAS® High Performance Analytics Server, SAS® LASR™′ SAS® In-Database Products, SAS® Scalable Performance Data Engine, SAS/OR®, SAS/ETS®, SAS® Inventory Optimization, SAS® Inventory Optimization Workbench, SAS® Visual Analytics, SAS® Viya™, SAS In-Memory Statistics for Hadoop®, SAS® Forecast Server, all of which are developed and provided by SAS Institute Inc. of Cary, N.C., USA. Data mining is applicable in a wide variety of industries.

Training application 122 may be integrated with other system processing tools to automatically process data generated as part of operation of an enterprise, device, system, facility, etc., to identify any outliers in the processed data, to monitor changes in the data, and to provide a warning or alert associated with the monitored data using input interface 102, output interface 104, and/or communication interface 106 so that appropriate action can be initiated in response to changes in the monitored data.

Training application 122 may be implemented as a Web application. For example, training application 122 may be configured to receive hypertext transport protocol (HTTP) responses and to send HTTP requests. The HTTP responses may include web pages such as hypertext markup language (HTML) documents and linked objects generated in response to the HTTP requests. Each web page may be identified by a uniform resource locator (URL) that includes the location or address of the computing device that contains the resource to be accessed in addition to the location of the resource on that computing device. The type of file or resource depends on the Internet application protocol such as the file transfer protocol, HTTP, H.323, etc. The file accessed may be a simple text file, an image file, an audio file, a video file, an executable, a common gateway interface application, a Java applet, an extensible markup language (XML) file, or any other type of file supported by HTTP.

Training dataset 124 may include, for example, a plurality of rows and a plurality of columns. The plurality of rows may be referred to as observation vectors or records (observations), and the columns may be referred to as variables. Training dataset 124 may be transposed. Training dataset 124 may include unsupervised data. The plurality of variables may define multiple dimensions for each observation vector. An observation vector xᵢ may include a value for each of the plurality of variables associated with the observation i. All or a subset of the columns may be used as variables used to define observation vector xᵢ. Each variable of the plurality of variables describes a characteristic of a physical object. For example, if training dataset 124 includes data related to operation of a vehicle, the variables may include an oil pressure, a speed, a gear indicator, a gas tank level, a tire pressure for each tire, an engine temperature, a radiator level, etc. Training dataset 124 may include data captured as a function of time for one or more physical objects.

The data stored in training dataset 124 may be generated by and/or captured from a variety of sources including one or more sensors of the same or different type, one or more computing devices, etc. The data stored in training dataset 124 may be received directly or indirectly from the source and may or may not be pre-processed in some manner. For example, the data may be pre-processed using an event stream processor such as the SAS® Event Stream Processing, developed and provided by SAS Institute Inc. of Cary, N.C., USA. As used herein, the data may include any type of content represented in any computer-readable format such as binary, alphanumeric, numeric, string, markup language, etc. The data may be organized using delimited fields, such as comma or space separated fields, fixed width fields, using a SAS® dataset, etc. The SAS dataset may be a SAS® file stored in a SAS® library that a SAS® software tool creates and processes. The SAS dataset contains data values that are organized as a table of observations (rows) and variables (columns) that can be processed by one or more SAS software tools.

Training dataset 124 may be stored on computer-readable medium 108 or on one or more computer-readable media of a distributed computing system 128 and accessed by SVDD training device 100 using communication interface 106, input interface 102, and/or output interface 104. Data stored in training dataset 124 may be sensor measurements or signal values captured by a sensor, may be generated or captured in response to occurrence of an event or a transaction, generated by a device such as in response to an interaction by a user with the device, etc. The data stored in training dataset 124 may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art. The data stored in training dataset 124 may be captured at different time points periodically, intermittently, when an event occurs, etc. One or more columns of training dataset 124 may include a time and/or date value.

Training dataset 124 may include data captured under normal operating conditions of the physical object. Training dataset 124 may include data captured at a high data rate such as 200 or more observations per second for one or more physical objects. For example, data stored in training dataset 124 may be generated as part of the Internet of Things (IoT), where things (e.g., machines, devices, phones, sensors) can be connected to networks and the data from these things collected and processed within the things and/or external to the things before being stored in training dataset 124. For example, the IoT can include sensors in many different devices and types of devices, and high value analytics can be applied to identify hidden relationships and drive increased efficiencies. This can apply to both big data analytics and real-time analytics. Some of these devices may be referred to as edge devices, and may involve edge computing circuitry. These devices may provide a variety of stored or generated data, such as network data or data specific to the network devices themselves. Some data may be processed with an event stream processing engine (ESPE), which may reside in the cloud or in an edge device before being stored in training dataset 124.

Training dataset 124 may be stored using various data structures as known to those skilled in the art including one or more files of a file system, a relational database, one or more tables of a system of tables, a structured query language database, etc. on SVDD training device 100 or on distributed computing system 128. SVDD training device 100 may coordinate access to training dataset 124 that is distributed across distributed computing system 128 that may include one or more computing devices. For example, training dataset 124 may be stored in a cube distributed across a grid of computers as understood by a person of skill in the art. As another example, training dataset 124 may be stored in a multi-node Hadoop® cluster. For instance, Apache™ Hadoop® is an open-source software framework for distributed computing supported by the Apache Software Foundation. As another example, training dataset 124 may be stored in a cloud of computers and accessed using cloud computing technologies, as understood by a person of skill in the art. The SAS® LASR™ Analytic Server may be used as an analytic platform to enable multiple users to concurrently access data stored in training dataset 124. The SAS® Viya™ open, cloud-ready, in-memory architecture also may be used as an analytic platform to enable multiple users to concurrently access data stored in training dataset 124. Some systems may use SAS In-Memory Statistics for Hadoop® to read big data once and analyze it several times by persisting it in-memory for the entire session. Some systems may be of other types and configurations.

An SVDD model is used in domains where a majority of data in training dataset 124 belongs to a single class. An SVDD model for normal data description builds a minimum radius hypersphere around the data. The objective function for the SVDD model for normal data description is

max(Σᵢ₌₁ⁿαᵢ(xᵢ·xᵢ)−Σᵢ₌₁ⁿΣⱼ₌₁^{u}αᵢαⱼ(xᵢ·xⱼ)), (1)

subject to:

Σᵢ₌₁ⁿαᵢ=1 (2)

0≤αᵢ≤C,∇∀i=1, . . . ,n, (3)

where xᵢ∈ [symbol] ^{m}, i=1, . . . , n represents n observations in training dataset 124, αᵢ∈ [symbol] are Lagrange constants, C=1/nf is a penalty constant that controls a trade-off between a volume and errors, and f is an expected outlier fraction. The expected outlier fraction is generally known to an analyst. Data preprocessing can ensure that training dataset 124 belongs to a single class. In this case, f can be set to a very low value such as 0.001. SV is the set of support vectors that includes the observation vectors in training dataset 124 that have C≥αᵢ>0 after solving equation (1) above. SV_{<C} is a subset of the support vectors that includes the observation vectors in training dataset 124 that have C>αᵢ>0 after solving equation (1) above. The SV_{<C} is a subset of the support vectors located on a boundary of the minimum radius hypersphere defined around the data.

Depending upon a position of an observation vector, the following results are true:

Center position:Σᵢ₌₁ⁿαᵢxᵢ=a. (4)

Inside position:∥xᵢ−a∥<R→αᵢ=0. (5)

Boundary position:∥xᵢ−a∥=R→0<αᵢ<C. (6)

Outside position:∥xᵢ−a∥>R→αᵢ=C. (7)

where a is a center of the hypersphere and R is a radius of the hypersphere. The radius of the hypersphere is calculated using:

R²=xₖ·xₖ−2Σᵢ₌₁^{N}^{_{SV}}αᵢ(xᵢ·xₖ)+Σᵢ₌₁^{N}^{_{SV}}Σⱼ₌₁^{N}^{_{SV}}αᵢαⱼ(xᵢ·xⱼ) (8)

where any xₖ∈SV_{<C}, xᵢ and xⱼ are the support vectors, αₜ and αⱼ are the Lagrange constants of the associated support vector, and N_{SV} is a number of the support vectors included in the set of support vectors. An observation vector z is indicated as an outlier when dist²(z)>R², where

dist²(z)=(z·z)−2Σᵢ₌₁^{N}^{_{SV}}αᵢ(xᵢ·z)+Σᵢ₌₁^{N}^{_{SV}}Σⱼ₌₁^{N}^{_{SV}}αᵢαⱼ(xᵢ·xⱼ). (9)

When the outlier fraction f is very small, the penalty constant C is very large resulting in few if any observation vectors in training dataset 124 determined to be in the outside position according to equation (7).

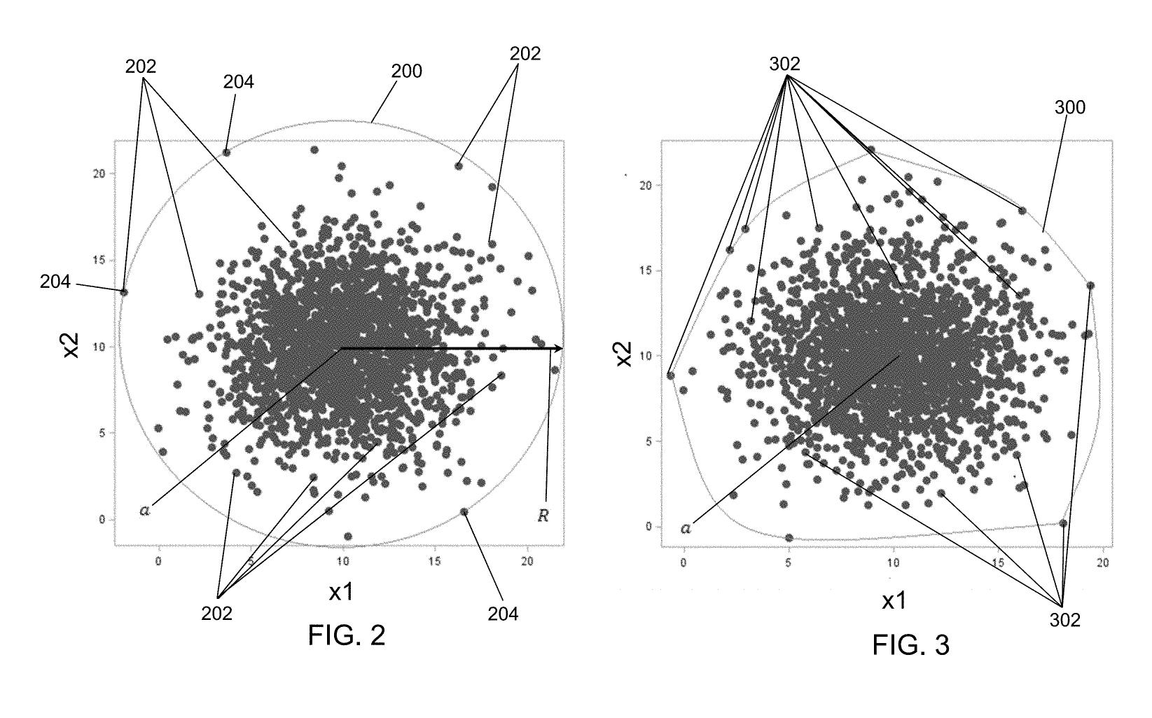

Referring to FIG. 2, an SVDD is illustrated in accordance with an illustrative embodiment that defines a boundary 200 having a radius R from a center a. Boundary 200 is characterized by observation vectors 202 (shown as data points on the graph), which are the set of support vectors SV. For illustration, observation vectors 202 are defined by values of variables x1 and x2 though observation vectors 202 may include a greater number of variables. The SV_{<C} 204 are the subset of support vectors SV on boundary 200.

Boundary 200 includes a significant amount of space with a very sparse distribution of training observations. Scoring with the model based on the set of support vectors SV that define boundary 200 can increase the probability of false positives. Instead of a circular shape, a compact bounded outline around the data that better approximates a shape of data in training dataset 124 may be preferred. This is possible using a kernel function. The SVDD is made flexible by replacing the inner product (xᵢ·x₁) with a suitable kernel function K (xᵢ, xⱼ). A Gaussian kernel function is used herein. The Gaussian kernel function may be defined as:

$$K ( {x}_{i} , {x}_{j} ) = exp \frac{- {‖ {x}_{i} - {x}_{j} ‖}^{2}}{2 {s}^{2}} \qquad ( 10 )$$

where s is the Gaussian bandwidth parameter.

The objective function for the SVDD model with the Gaussian kernel function is

max(Σᵢ₌₁ⁿαᵢK(xᵢ,xᵢ)−Σᵢ₌₁ⁿΣⱼ₌₁^{u}αᵢαⱼK(xᵢ,xⱼ)), (11)

subject to:

Σᵢ₌₁ⁿαᵢ=1, (12)

0≤αᵢ≤C,∀i=1, . . . ,n (13)

where again SV is the set of support vectors that includes the observation vectors in training dataset 124 that have C≥αᵢ>0 after solving equation (1) above. SV_{<C} is the subset of the support vectors that includes the observation vectors in training dataset 124 that have C>αᵢ>0 after solving equation (1) above.

The results from equations (4) to (7) above remain valid. A threshold R is computed using:

R²=K(xₖ,xₖ)−2Σᵢ₌₁^{N}^{_{SV}}αᵢK(xᵢ,xₖ)+Σᵢ₌₁^{N}^{_{SV}}Σⱼ₌₁^{N}^{_{SV}}αᵢαⱼK(xᵢ,xₖ) (14)

where any xₖ∈SV_{<C}, where xᵢ and xⱼ are the support vectors, αᵢ and αⱼ are the Lagrange constants of the associated support vector, and N_{SV} is a number of the support vectors included in the set of support vectors.

An observation vector z is indicated as an outlier when dist²(z)>R², where

dist²(z)=K(z,z)−2Σᵢ₌₁^{N}^{_{SV}}αᵢK(xᵢ,z)+Σᵢ₌₁^{N}^{_{SV}}Σⱼ₌₁^{N}^{_{SV}}αᵢαⱼK(xᵢ,xⱼ). (15)

Σᵢ₌₁^{N}^{_{SV}}Σⱼ₌₁^{N}^{_{SV}}αᵢαⱼK(xᵢ,xⱼ) is a constant that can be denoted as W and that can be determined from the set of support vectors. R² is a threshold determined using the set of support vectors. For a Gaussian kernel function, K(z,z)=1. Thus, equation (14) can be simplified to dist²(z)=1−2 Σᵢ₌₁^{N}^{_{SV}}αᵢK(xᵢ, z)+W for a Gaussian kernel function.

Referring to FIG. 3, a SVDD is shown in accordance with an illustrative embodiment that defines a flexible boundary 300. The SVDD is characterized by support vectors 302, which are the set of support vectors SV. The SV_{<C} are the subset of support vectors SV shown on flexible boundary 300.

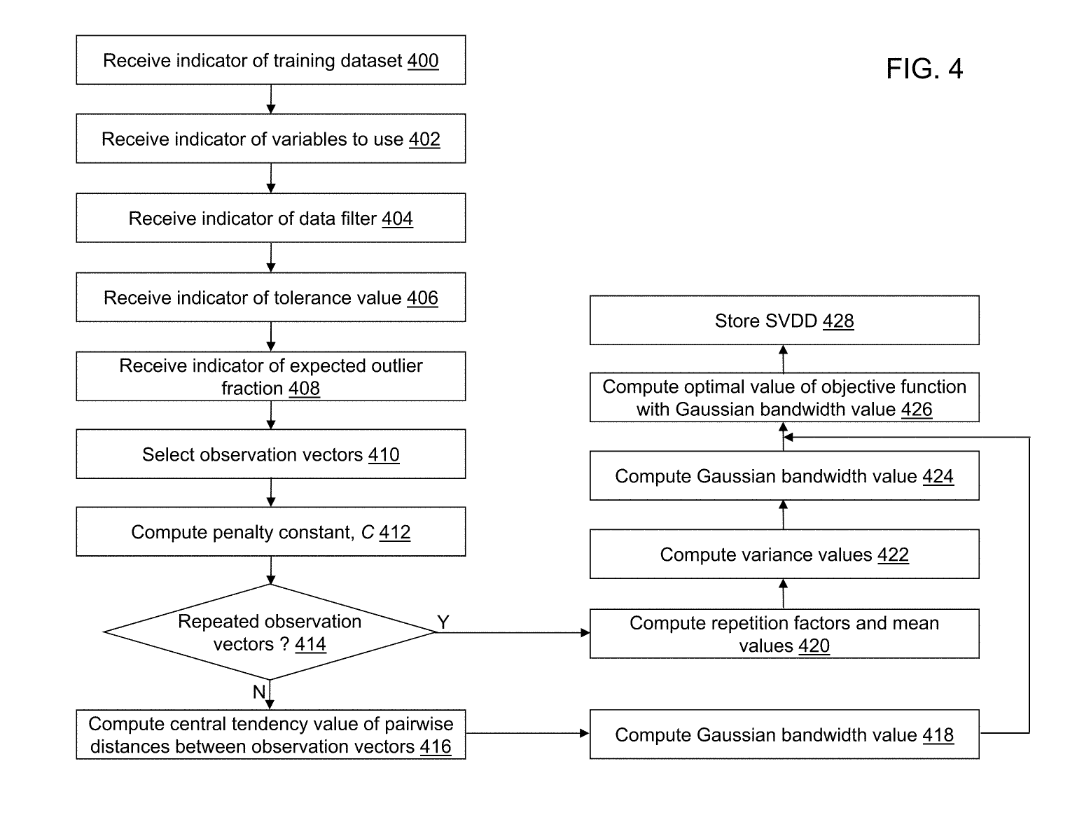

Referring to FIG. 4, example operations associated with training application 122 are described. For example, training application 122 may be used to compute a value for the Gaussian bandwidth parameter s and to compute SVDD 126 from training dataset 124. Additional, fewer, or different operations may be performed depending on the embodiment of training application 122. The order of presentation of the operations of FIG. 4 is not intended to be limiting. Although some of the operational flows are presented in sequence, the various operations may be performed in various repetitions, concurrently (in parallel, for example, using threads and/or a distributed computing system), and/or in other orders than those that are illustrated. For example, a user may execute training application 122, which causes presentation of a first user interface window, which may include a plurality of menus and selectors such as drop down menus, buttons, text boxes, hyperlinks, etc. associated with training application 122 as understood by a person of skill in the art. The plurality of menus and selectors may be accessed in various orders. An indicator may indicate one or more user selections from a user interface, one or more data entries into a data field of the user interface, one or more data items read from computer-readable medium 108 or otherwise defined with one or more default values, etc. that are received as an input by training application 122.

Referring to FIG. 4, in an operation 400, a first indicator may be received that indicates training dataset 124. For example, the first indicator indicates a location and a name of training dataset 124. As an example, the first indicator may be received by training application 122 after selection from a user interface window or after entry by a user into a user interface window. In an alternative embodiment, training dataset 124 may not be selectable. For example, a most recently created dataset may be used automatically.

In an operation 402, a second indicator may be received that indicates a plurality of variables of training dataset 124 to define xᵢ. The second indicator may indicate that all or only a subset of the variables stored in training dataset 124 be used to define SVDD 126. For example, the second indicator indicates a list of variables to use by name, column number, etc. In an alternative embodiment, the second indicator may not be received. For example, all of the variables may be used automatically.

In an operation 404, a third indicator is received that indicates a data filter for a plurality of observations of training dataset 124. The third indicator may indicate one or more rules associated with selection of an observation from the plurality of observations of training dataset 124. In an alternative embodiment, the third indicator may not be received. For example, no filtering of the plurality of observations may be applied. As an example, data may be captured for a vibration level of a washing machine. A washing machine mode, such as “fill’, “wash”, “spin”, etc. may be captured. Because a “normal” vibration level may be different dependent on the washing machine mode, a subset of data may be selected for a specific washing machine mode setting based on a value in a column of training dataset 124 that defines the washing machine mode. For example, SVDD models may be defined for different modes of the machine such that the data filter identifies a column indicating the washing machine mode and which value(s) is(are) used to define the SVDD model.

In an operation 406, a fourth indicator of a tolerance value δ may be received. In an alternative embodiment, the fourth indicator may not be received. For example, a default value may be stored, for example, in computer-readable medium 108 and used automatically. In another alternative embodiment, the value of the tolerance value δ may not be selectable. Instead, a fixed, predefined value may be used. For illustration, a value of \sqrt{2}×10⁻⁷≤δ≤\sqrt{2}×10⁻⁵. For further illustration, a value of δ=\sqrt{2}×10⁻⁶ has been shown to work well for most training datasets.

In an operation 408, a fifth indicator of a value of the expected outlier fraction f may be received. In an alternative embodiment, the fifth indicator may not be received. For example, a default value may be stored, for example, in computer-readable medium 108 and used automatically. In another alternative embodiment, the value of the expected outlier fraction f may not be selectable. Instead, a fixed, predefined value may be used.

In an operation 410, a number of observation vectors N is selected after reading all of the observation vectors from training dataset 124 and after applying the data filter indicated in operation 404, if any, to define a selected set of observation vectors X, where xᵢ∈X, and xᵢ, i=1, N. The selected set of observation vectors X are processed to compute SVDD 126.

In an operation 412, a value of the penalty constant C=1/Nf may be computed from N and f.

In an operation 414, a determination is made concerning whether or not any xᵢ of the selected set of observation vectors X is a repeat of another observation vector xⱼ. When at least one observation vector is repeated, processing continues in an operation 420. When the observation vectors are each unique, processing continues in an operation 416.

In operation 416, a central tendency value is computed for pairwise distances between observation vectors. In an illustrative embodiment, a mean pairwise distance D̅ is computed using

$${\overline{D}}^{2} = {\sum }_{i < j} {‖ {x}_{i} - {x}_{j} ‖}^{2} / ( \begin{matrix}N \\ 2\end{matrix} ) = \frac{2 N}{( N - 1 )} {\sum }_{j = 1}^{p} {σ}_{j}^{2} ,$$

1, . . . , N and j=1, . . . , N, where p is a number of variables that define each observation vector xᵢ and σⱼ² is a variance of each variable of the number of variables. For illustration, each σⱼ² is computed using

$${σ}_{1}^{2} = \frac{{\sum }_{i = 1}^{N} {( {x}_{i 1} - {μ}_{1} )}^{2}}{N} , where {μ}_{1} = \frac{{\sum }_{i = 1}^{N} {x}_{i 1}}{N}$$

is a mean value computed for a first variable from each observation vector value for the first variable of the selected set of observation vectors X, . . . ,

$${σ}_{1 p}^{2} = \frac{{\sum }_{i = 1}^{N} {( {x}_{ip} - {μ}_{p} )}^{2}}{N} , where {μ}_{p} = \frac{{\sum }_{i = 1}^{N} {x}_{ip}}{N}$$

is a mean value computed for a pth variable from each observation vector value for the pth variable of the selected set of observation vectors X. Because the column variances can be calculated in one pass through the selected set of observation vectors X, the computation of mean pairwise distance D̅ is an [symbol] (Np) algorithm.

In another illustrative embodiment, a median pairwise distance D_{md} is computed using D_{md}=median_{i<j}∥xᵢ−xⱼ∥, i=1, . . . , N and j=1, . . . , N. The user may select either mean pairwise distance D̅ or median pairwise distance D_{md} to use or a single pairwise distance value may be used without user selection.

In an operation 418, the Gaussian bandwidth parameters is computed from either mean pairwise distance D or median pairwise distance D_{md} and a scaling factor F, where F=1/\sqrt{ln[(N−1)/δ²]}. For example, s=\sqrt{D̅²/ln[(N−1)/δ²]}=D̅F or s=D_{md}/\sqrt{ln[(N−1)/δ²]}=D_{md}F, and processing continues in an operation 426. As a result, the Gaussian bandwidth parameter s is computed as the scaling factor F multiplied by the computed central tendency value that is either mean pairwise distance D̅ or median pairwise distance D_{md}.

In operation 420, repetition weight factors, W, M, and Q, are computed from a repetition vector wᵢ where xᵢ is repeated wᵢ>0 times and i=1, . . . , N. W=Σᵢ₌₁^{N}wᵢ, M=Σᵢ₌₁^{N}wᵢ², and Q=(W²−M)/2, where {x₁, . . . , x_{N}} are the distinct observation vectors included in the selected set of observation vectors X.

In an operation 422, a variance value σ⁻² is computed from the selected set of observation vectors X, where σ⁻²=Σᵢ₌₁^{p}σᵢ², where each σᵢ² computing using

$${σ}_{1}^{2} = \frac{{\sum }_{i = 1}^{N} {{w}_{i} ( {x}_{i 1} - {μ}_{1} )}^{2}}{W} , … , {σ}_{p}^{2} = \frac{{\sum }_{i = 1}^{N} {w}_{i} {‖ {x}_{ip} - {μ}_{p} ‖}^{2}}{W} , where$$

$${μ}_{1} = \frac{{\sum }_{i = 1}^{N} {w}_{i} {x}_{i 1}}{W} , … , {μ}_{p} = \frac{{\sum }_{i = 1}^{N} {w}_{i} {x}_{ip}}{W}$$

where p is the number of variables that define each observation vector xᵢ.

In an operation 424, the Gaussian bandwidth parameter s is computed from the variance value σ² and a weighed scaling factor F_{W}, where F_{W}=W/\sqrt{Q×ln[2Q/(δ²M)]}. For example, s=σF_{W}, where σ=\sqrt{σ²}, and processing continues in operation 426.

In operation 426, an optimal value is computed for the objective function of the SVDD model using the Gaussian kernel function with the computed Gaussian bandwidth parameter s and the selected set of observation vectors X. For example, equations (11)-(13) above are used to solve for SV, a set of support vectors that have 0<αᵢ≤C. Values for the Lagrange constants αᵢ for each support vector of the set of support vectors, for R² using equation (14), and for the center position α using equation (4) are computed as part of the optimal solution. Only the SV_{<C} are needed for the computations of R², and only the SV are needed for the computations of a.

In an operation 428, the set of support vectors SV, the Lagrange constants αᵢ for each support vector of the set of support vectors SV, the center position a, and/or R² computed from the set of support vectors may be stored in SVDD 126 in association with the computed Gaussian bandwidth parameter s.

Referring to FIG. 18, a block diagram of an outlier identification device 1800 is shown in accordance with an illustrative embodiment. Outlier identification device 1800 may include a second input interface 1802, a second output interface 1804, a second communication interface 1806, a second non-transitory computer-readable medium 1808, a second processor 1810, an outlier identification application 1822, SVDD 126, a dataset 1824, and an outlier dataset 1826. Fewer, different, and/or additional components may be incorporated into outlier identification device 1800. Outlier identification device 1800 and SVDD training device 100 may be the same or different devices.

Second input interface 1802 provides the same or similar functionality as that described with reference to input interface 102 of SVDD training device 100 though referring to outlier identification device 1800. Second output interface 1804 provides the same or similar functionality as that described with reference to output interface 104 of SVDD training device 100 though referring to outlier identification device 1800. Second communication interface 1806 provides the same or similar functionality as that described with reference to communication interface 106 of SVDD training device 100 though referring to outlier identification device 1800. Data and messages may be transferred between outlier identification device 1800 and distributed computing system 128 using second communication interface 1806. Second computer-readable medium 1808 provides the same or similar functionality as that described with reference to computer-readable medium 108 of SVDD training device 100 though referring to outlier identification device 1800. Second processor 1810 provides the same or similar functionality as that described with reference to processor 110 of SVDD training device 100 though referring to outlier identification device 1800.

Outlier identification application 1822 performs operations associated with creating outlier dataset 1826 from data stored in dataset 1824 using SVDD 126. SVDD 126 may be used to classify data stored in dataset 1824 and to identify outliers in dataset 1824 that are then stored in outlier dataset 1826 to support various data analysis functions as well as provide alert/messaging related to the identified outliers stored in outlier dataset 1826. Dependent on the type of data stored in training dataset 124 and dataset 1824, outlier dataset 1826 may identify anomalies as part of process control, for example, of a manufacturing process, for machine condition monitoring, for example, of an electro-cardiogram device, for image classification, for intrusion detection, for fraud detection, etc. Some or all of the operations described herein may be embodied in outlier identification application 1822. The operations may be implemented using hardware, firmware, software, or any combination of these methods.

Referring to the example embodiment of FIG. 18, outlier identification application 1822 is implemented in software (comprised of computer-readable and/or computer-executable instructions) stored in second computer-readable medium 1808 and accessible by second processor 1810 for execution of the instructions that embody the operations of outlier identification application 1822. Outlier identification application 1822 may be written using one or more programming languages, assembly languages, scripting languages, etc. Outlier identification application 1822 may be integrated with other analytic tools. For example, outlier identification application 1822 may be part of SAS® Enterprise Miner™ and/or SAS® Viya™ developed and provided by SAS Institute Inc. of Cary, N.C. that may be used to create highly accurate predictive and descriptive models based on analysis of vast amounts of data from across an enterprise. Outlier identification application 1822 further may be incorporated into SAS® Event Stream Processing.

Outlier identification application 1822 may be implemented as a Web application. Outlier identification application 1822 may be integrated with other system processing tools to automatically process data generated as part of operation of an enterprise, to identify any outliers in the processed data, and to provide a warning or alert associated with identification of an outlier using second input interface 1802, second output interface 1804, and/or second communication interface 1806 so that appropriate action can be initiated in response to the outlier identification. Outlier identification application 1822 and training application 122 further may be integrated applications.

Training dataset 124 and dataset 1824 may be generated, stored, and accessed using the same or different mechanisms. Similar to training dataset 124, dataset 1824 may include a plurality of rows and a plurality of columns with the plurality of rows referred to as observations or records, and the columns referred to as variables that are associated with an observation. Dataset 1824 may be transposed.

Similar to training dataset 124, dataset 1824 may be stored on second computer-readable medium 1808 or on one or more computer-readable media of distributed computing system 128 and accessed by outlier identification device 1800 using second communication interface 1806. Data stored in dataset 1824 may be a sensor measurement or a data communication value, may be generated or captured in response to occurrence of an event or a transaction, generated by a device such as in response to an interaction by a user with the device, etc. The data stored in dataset 1824 may include any type of content represented in any computer-readable format such as binary, alphanumeric, numeric, string, markup language, etc. The content may include textual information, graphical information, image information, audio information, numeric information, etc. that further may be encoded using various encoding techniques as understood by a person of skill in the art. The data stored in dataset 1824 may be captured at different time points periodically or intermittently, when an event occurs, etc. One or more columns may include a time value. Similar to training dataset 124, data stored in dataset 1824 may be generated as part of the IoT, and some or all data may be processed with an ESPE.

Similar to training dataset 124, dataset 1824 may be stored in various compressed formats such as a coordinate format, a compressed sparse column format, a compressed sparse row format, etc. Dataset 1824 further may be stored using various structures as known to those skilled in the art including a file system, a relational database, a system of tables, a structured query language database, etc. on SVDD training device 100, on outlier identification device 1800, and/or on distributed computing system 128. Outlier identification device 1800 and/or distributed computing system 128 may coordinate access to dataset 1824 that is distributed across a plurality of computing devices. For example, dataset 1824 may be stored in a cube distributed across a grid of computers as understood by a person of skill in the art. As another example, dataset 1824 may be stored in a multi-node Hadoop® cluster. For instance, Apache™ Hadoop® is an open-source software framework for distributed computing supported by the Apache Software Foundation. As another example, dataset 1824 may be stored in a cloud of computers and accessed using cloud computing technologies, as understood by a person of skill in the art. The SAS® LASR™ Analytic Server developed and provided by SAS Institute Inc. of Cary, N.C. may be used as an analytic platform to enable multiple users to concurrently access data stored in dataset 1824.

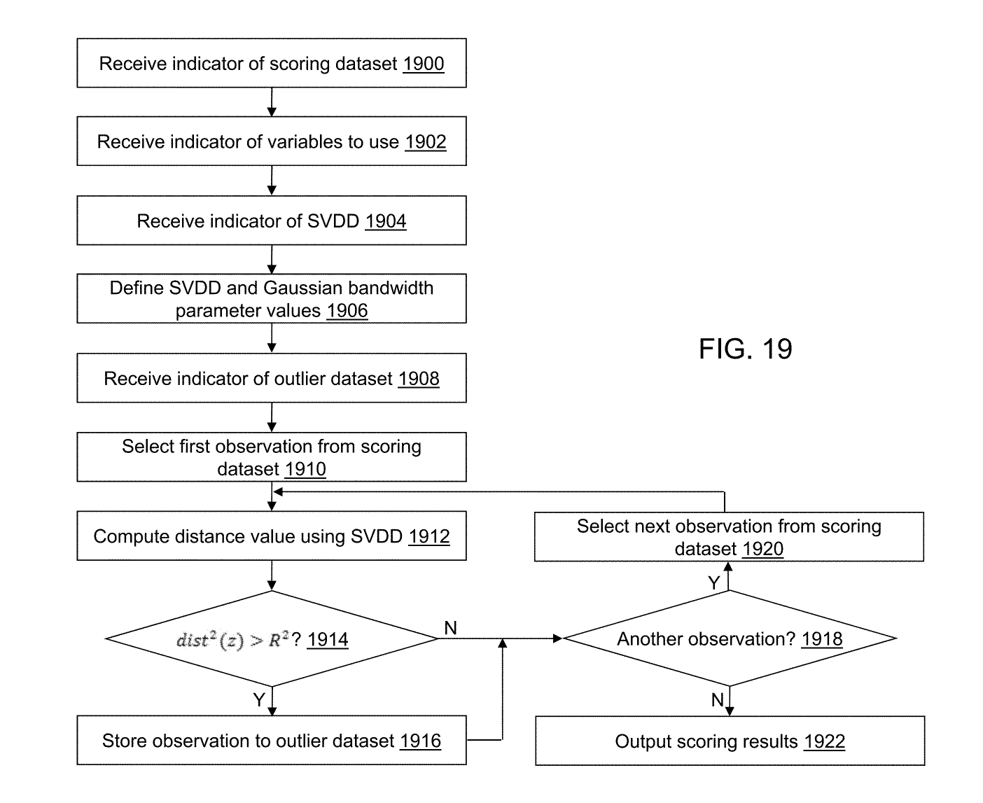

Referring to FIG. 19, example operations of outlier identification application 1822 to use SVDD 126 to classify dataset 1824 and create outlier dataset 1826 are described. Additional, fewer, or different operations may be performed depending on the embodiment of outlier identification application 1822. The order of presentation of the operations of FIG. 19 is not intended to be limiting. Although some of the operational flows are presented in sequence, the various operations may be performed in various repetitions, concurrently (in parallel, for example, using threads and/or a distributed computing system), and/or in other orders than those that are illustrated. For example, a user may execute outlier identification application 1822, which causes presentation of a first user interface window, which may include a plurality of menus and selectors such as drop down menus, buttons, text boxes, hyperlinks, etc. associated with outlier identification application 1822 as understood by a person of skill in the art. The plurality of menus and selectors may be accessed in various orders. An indicator may indicate one or more user selections from a user interface, one or more data entries into a data field of the user interface, one or more data items read from second computer-readable medium 1808 or otherwise defined with one or more default values, etc. that are received as an input by outlier identification application 1822.

In an operation 1900, a sixth indicator is received that indicates dataset 1824. For example, the sixth fifteenth indicates a location and a name of dataset 1824. As an example, the sixth indicator may be received by outlier identification application 1822 after selection from a user interface window or after entry by a user into a user interface window. In an alternative embodiment, dataset 1824 may not be selectable. For example, a most recently created dataset may be used automatically or observation vectors may be streamed to outlier identification application 1822 from an event publishing application executing at a computing device of distributed computing system 128.

In an operation 1902, a seventh indicator may be received that indicates a plurality of variables of dataset 1824 to define observation vector z. The same set of the plurality of variables selected in operation 402 to define SVDD 126 should be selected. The seventh indicator may indicate that all or only a subset of the variables stored in dataset 1824 be used to determine whether the observation vector z is an outlier. For example, the seventh indicator indicates a list of variables to use by name, column number, etc. In an alternative embodiment, the seventh indicator may not be received. For example, all of the variables may be used automatically.

In an operation 1904, an eighth indicator is received that indicates SVDD 126. For example, the eighth indicator indicates a location and a name of SVDD 126. As an example, the eighth indicator may be received by outlier identification application 1822 after selection from a user interface window or after entry by a user into a user interface window. In an alternative embodiment, SVDD 126 may not be selectable. For example, a default name and location for SVDD 126 may be used automatically.

In an operation 1906, the set of support vectors SV, the Lagrange constants αᵢ for each support vector of the set of support vectors SV, the center position a, R², and the Gaussian bandwidth parameters are defined. For example, the set of support vectors SV, the Lagrange constants αᵢ for each support vector of the set of support vectors SV, the center position a, R², and the Gaussian bandwidth parameters are read from SVDD 126 though the center position a and R² may be computed from the set of support vectors SV and the Lagrange constants αᵢ instead.

In an operation 1908, a ninth indicator is received that indicates outlier dataset 1826. For example, the ninth indicator indicates a location and a name of outlier dataset 1826. As an example, the ninth indicator may be received by outlier identification application 1822 after selection from a user interface window or after entry by a user into a user interface window. In an alternative embodiment, outlier dataset 1826 may not be selectable. For example, a default name and location for outlier dataset 1826 may be used automatically.

In an operation 1910, a first observation is read from dataset 1824 and selected as observation vector z. In another embodiment, the first observation may be received from another computing device in an event stream and selected as observation vector z. In still another embodiment, the first observation may be received from a sensor 1812 through second input interface 1802 or second communication interface 1806 and selected as observation vector z. The observation vector may include values received from a plurality of sensors of the same or different types connected to a device or mounted in a location or an area. For example, sensor 1812 may produce a sensor signal value referred to as a measurement data value representative of a measure of a physical quantity in an environment to which sensor 1812 is associated and generate a corresponding measurement datum that may be associated with a time that the measurement datum is generated. The environment to which sensor 1812 is associated for monitoring may include a power grid system, a telecommunications system, a fluid (oil, gas, water, etc.) pipeline, a transportation system, an industrial device, a medical device, an appliance, a vehicle, a computing device, etc. Example sensor types of sensor 1812 include a pressure sensor, a temperature sensor, a position or location sensor, a velocity sensor, an acceleration sensor, a fluid flow rate sensor, a voltage sensor, a current sensor, a frequency sensor, a phase angle sensor, a data rate sensor, a humidity sensor, an acoustic sensor, a light sensor, a motion sensor, an electromagnetic field sensor, a force sensor, a torque sensor, a load sensor, a strain sensor, a chemical property sensor, a resistance sensor, a radiation sensor, an irradiance sensor, a proximity sensor, a distance sensor, a vibration sensor, etc. that may be mounted to various components used as part of the system.

In an operation 1912, a distance value for observation vector z is computed using dist²(z)=K(z,z)−2 Σᵢ₌₁^{N}^{_{SV}}αᵢK(xᵢ,z)+Σᵢ₌₁^{N}^{_{SV}}Σⱼ₌₁^{N}^{_{SV}}αᵢαⱼK(xᵢ,xⱼ), where K(.,.) is the Gaussian kernel function defined as:

$$K ( {x}_{i} , {x}_{j} ) = exp \frac{- {‖ {x}_{i} - {x}_{j} ‖}^{2}}{2 {s}^{2}}$$

where xᵢ is any support vector of the defined set of support vectors SV, N_{SV} is the number of support vectors included in the defined set of support vectors SV, and αᵢ is the Lagrange constant associated with support vector xᵢ. G=Σᵢ₌₁^{N}^{_{SV}}Σⱼ₌₁^{N}^{_{SV}}αᵢαⱼK(xᵢ,xⱼ) may have been computed from the defined set of support vectors SV and the Lagrange constants αᵢ for each support vector of the set of support vectors SV and stored in SVDD 126 in operation 428 or may have been computed after operation 1904 and before operation 1912 to save computing resources and time. For a Gaussian kernel function, K(z,z)=1. Thus, computation of the distance value can be simplified to dist²(z)=1−2 Σᵢ₌₁^{N}^{_{SV}}αᵢK(xᵢ, z)+G.

In an operation 1914, a determination is made concerning whether or not dist²(z)>R². When dist²(z)>R², processing continues in an operation 1916. When dist²(z)≤R², processing continues in an operation 1918.

In operation 1916, observation vector z and/or an indicator of observation vector z is stored to outlier dataset 1826, and processing continue in operation 1918.

In operation 1918, a determination is made concerning whether or not dataset 1824 includes another observation or another observation vector has been received. When there is another observation, processing continues in an operation 1920. When there is not another observation, processing continues in an operation 1922.

In operation 1920, a next observation is selected as observation vector z from dataset 1824 or is received, and processing continues in operation 1912 to determine if the next observation is an outlier.

In operation 1922, scoring results are output. For example, statistical results associated with the scoring may be stored on one or more devices and/or on second computer-readable medium 1808 in a variety of formats as understood by a person of skill in the art. Outlier dataset 1826 and/or the scoring results further may be output to a second display 1816, to a second printer 1820, etc. In an illustrative embodiment, an alert message may be sent to another device using second communication interface 1806, printed on second printer 1820 or another printer, presented visually on second display 1816 or another display, presented audibly using a second speaker 1818 or another speaker when an outlier is identified.

Because computation of an SVDD model is an unsupervised learning technique, it is desirable to have an unsupervised bandwidth parameter selection technique, such as that provided by training application 122, which does not depend on labeled data that separates the inliers from the outliers. Training application 122 includes two such techniques. The first technique uses mean pairwise distance D and is referred to herein as a mean criterion. The first technique can be applied with non-repeating observation vectors using operation 418 or repeating observation vectors using operation 424. The second technique uses median pairwise distance D_{md} and is referred to herein as a median criterion. U.S. Patent Publication No. 2017/0236074, titled KERNEL PARAMETER SELECTION IN SUPPORT VECTOR DATA DESCRIPTION FOR OUTLIER IDENTIFICATION, and assigned to SAS Institute Inc., the assignee of the present application, describes an unsupervised bandwidth selection technique referred to herein as a peak criterion. A paper by Charu C. Aggarwal, titled Outlier Analysis, and published by Springer Publishing Company, Incorporated in 2013 describes using F=1/\sqrt{2} resulting in s=D_{md}/\sqrt{2}=D_{md}F. Use of s=D_{md}/\sqrt{2} is referred to herein as a median₂ criterion.

The performance of the SVDD using the Gaussian bandwidth parameter s computed using the mean criterion, the median criterion, the peak criterion, and the median₂ criterion was compared with five different sample datasets. Training application 122 was executed with each sample dataset to compute the Gaussian bandwidth parameter s and the associated set of support vectors SV using the mean criterion and the median criterion. The peak criterion and the median₂ criterion were also implemented and the Gaussian bandwidth parameter s and the associated set of support vectors SV were also computed using each of those techniques. The Gaussian bandwidth parameter s and the associated set of support vectors SV computed using each of the four techniques was input to outlier identification application 1822. Dataset 1824 was created for each of the sample datasets using a bounding rectangle defined for the dataset. The observation vectors resulting from the bounding rectangle were two-dimensional and created by dividing each dataset into a 200×200 grid. The observation vectors not identified as outliers were graphed with the results presented below for each technique.

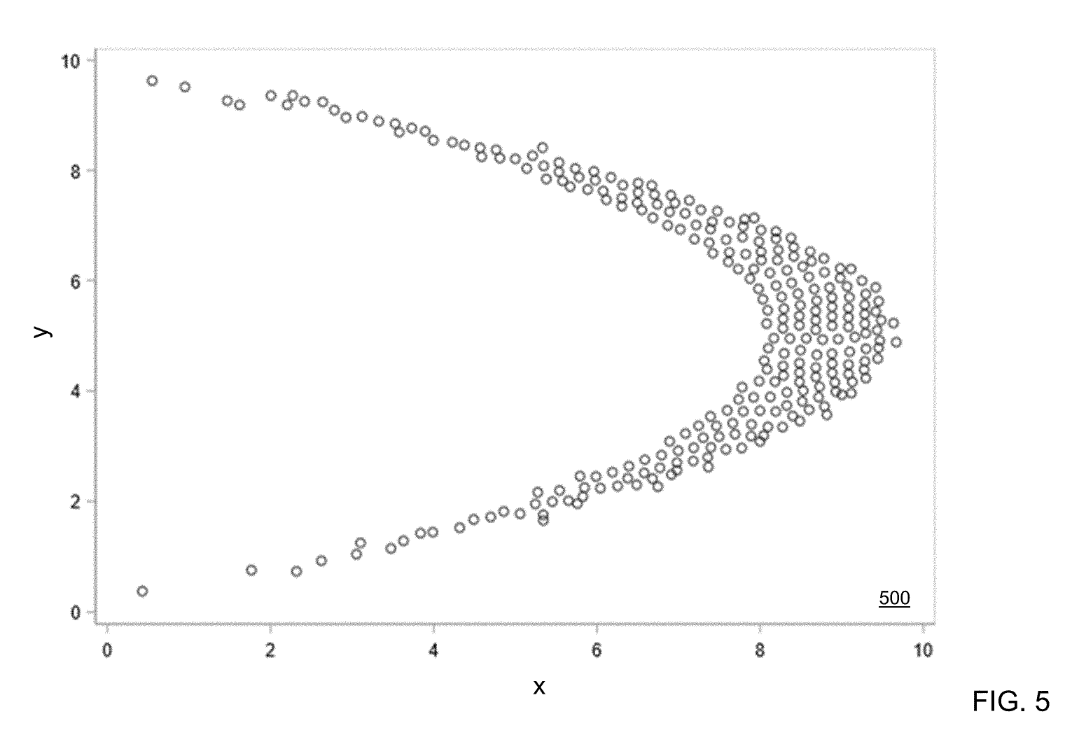

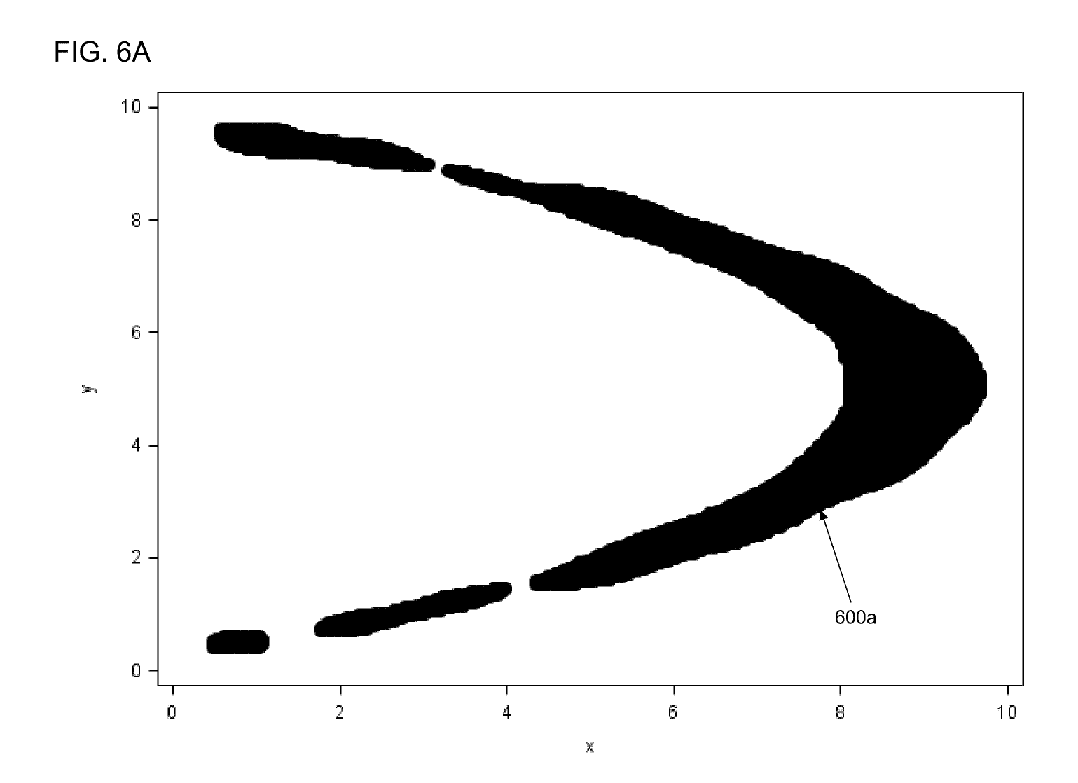

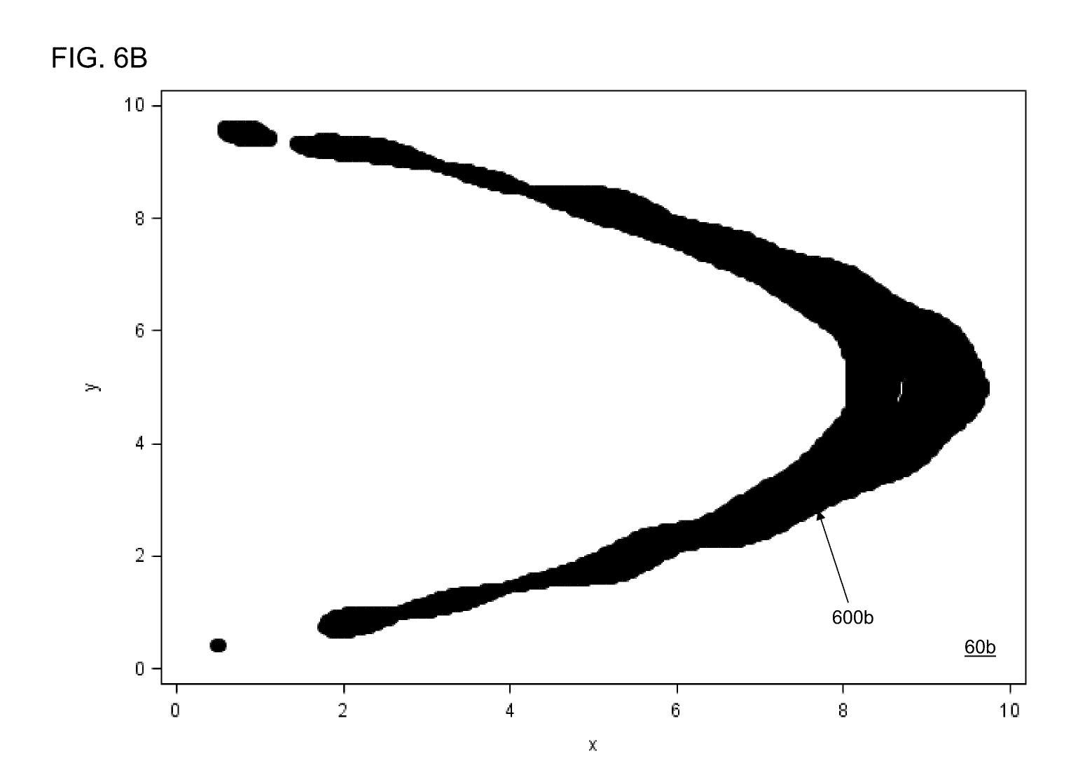

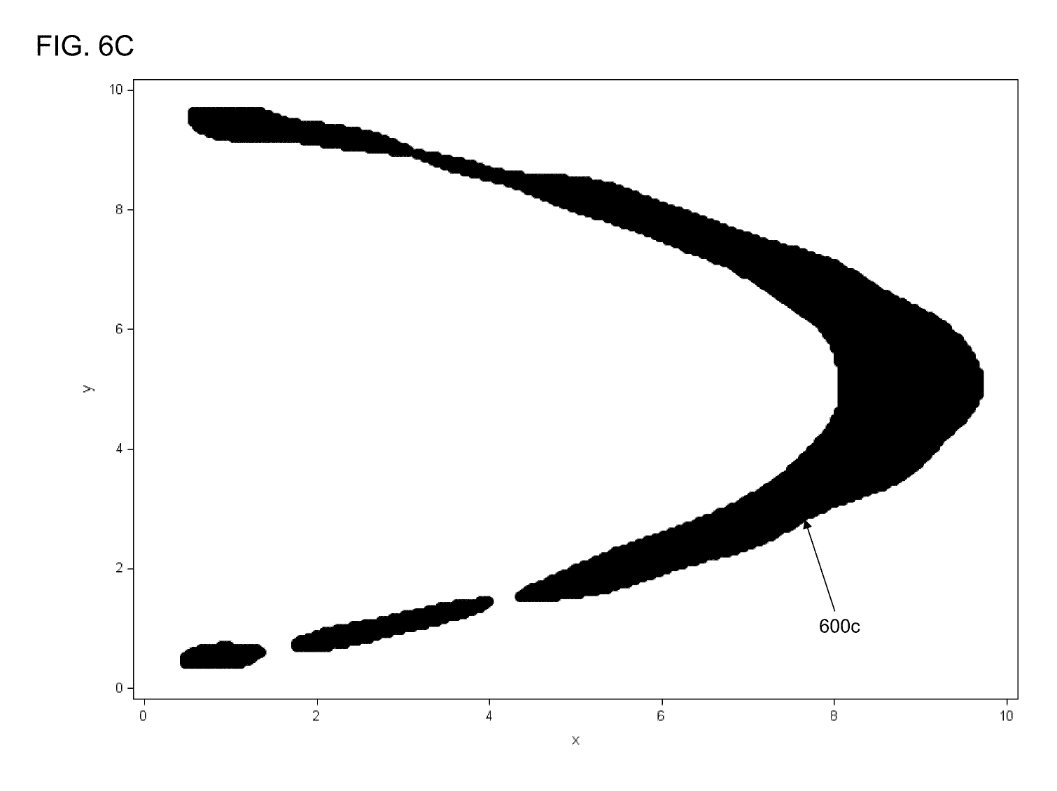

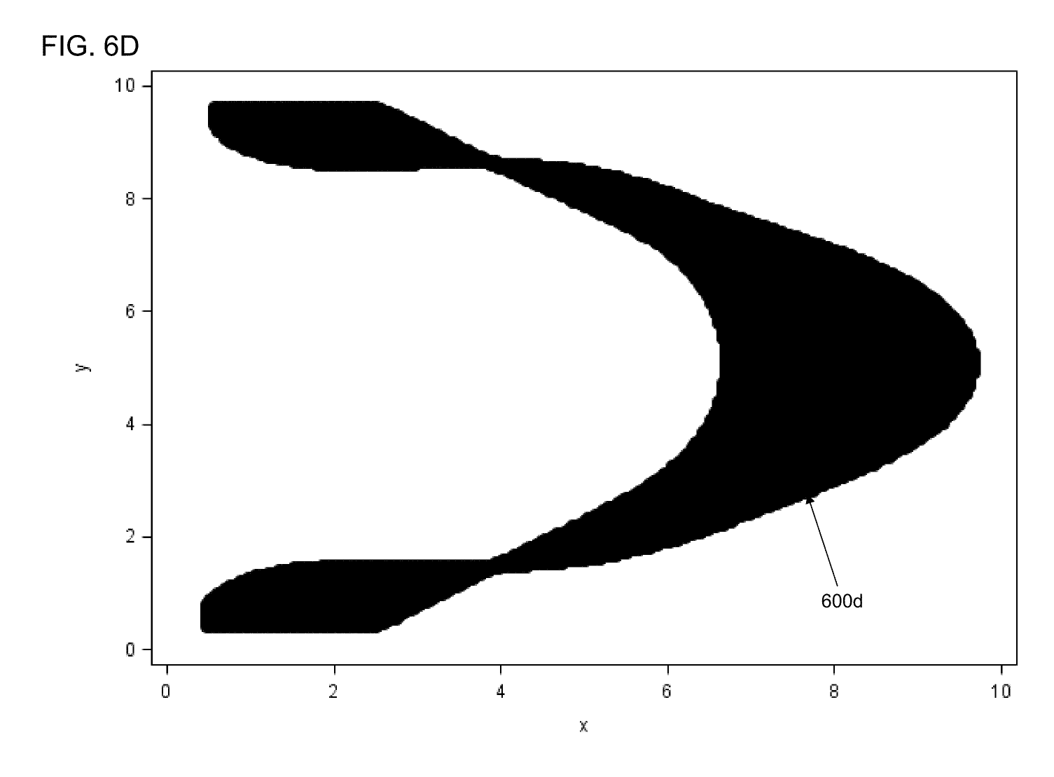

Referring to FIG. 5, a first sample dataset 500 having a banana shape is shown. Referring to FIGS. 6A to 6D, scoring results from outlier identification application 1822 using the Gaussian bandwidth parameters and the associated set of support vectors SV computed using the mean criterion, the median criterion, the peak criterion, and the median₂ criterion, respectively, are shown for dataset 1824 created from first sample dataset 500.

Referring to FIG. 6A, a first dark region 600a shows observation vectors not identified as outliers with the Gaussian bandwidth parameter s=0.734071 computed using the mean criterion technique. Referring to FIG. 6B, a second dark region 600b shows observation vectors not identified as outliers with the Gaussian bandwidth parameter s=0.553567 computed using the median criterion technique. Referring to FIG. 6C, a third dark region 600c shows observation vectors not identified as outliers with the Gaussian bandwidth parameter s=0.775 computed using the peak criterion technique. Referring to FIG. 6D, a fourth dark region 600d shows observation vectors not identified as outliers with the Gaussian bandwidth parameter s=2.232233 computed using the median₂ criterion technique.

The scoring results indicate that the Gaussian bandwidth parameter s computed using the mean and median criteria provides a good quality data description. The descriptions are close to the one obtained using the peak criterion. The median₂ criterion did not provide a quality data description.

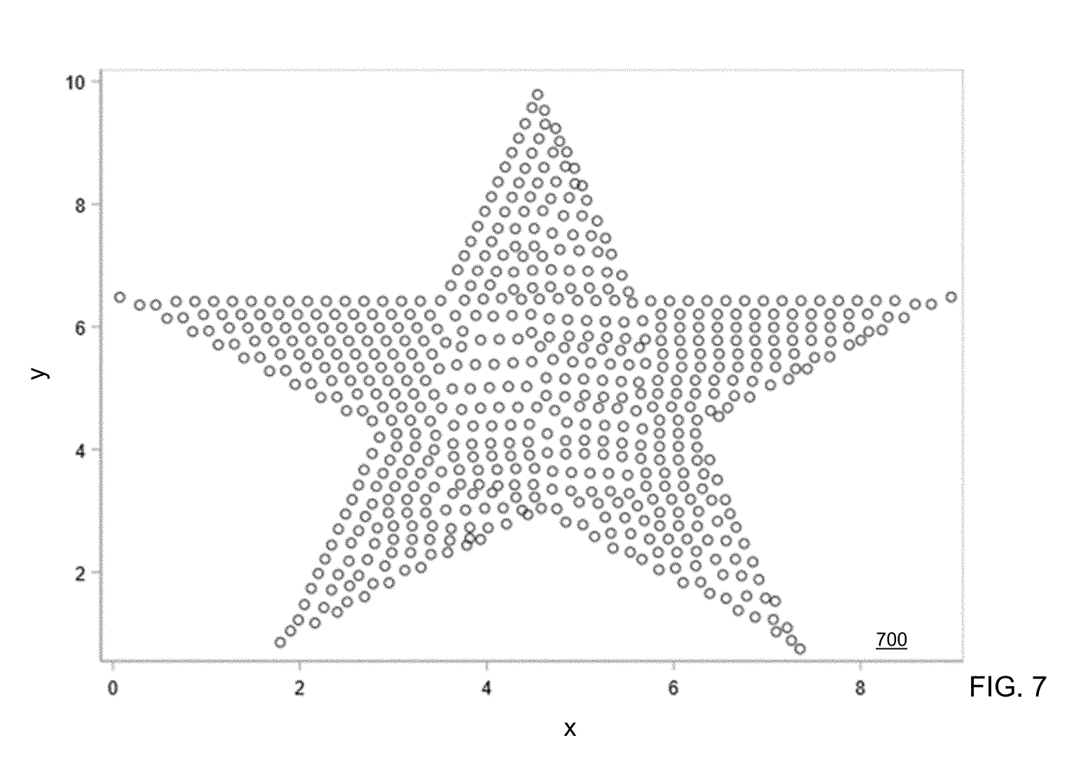

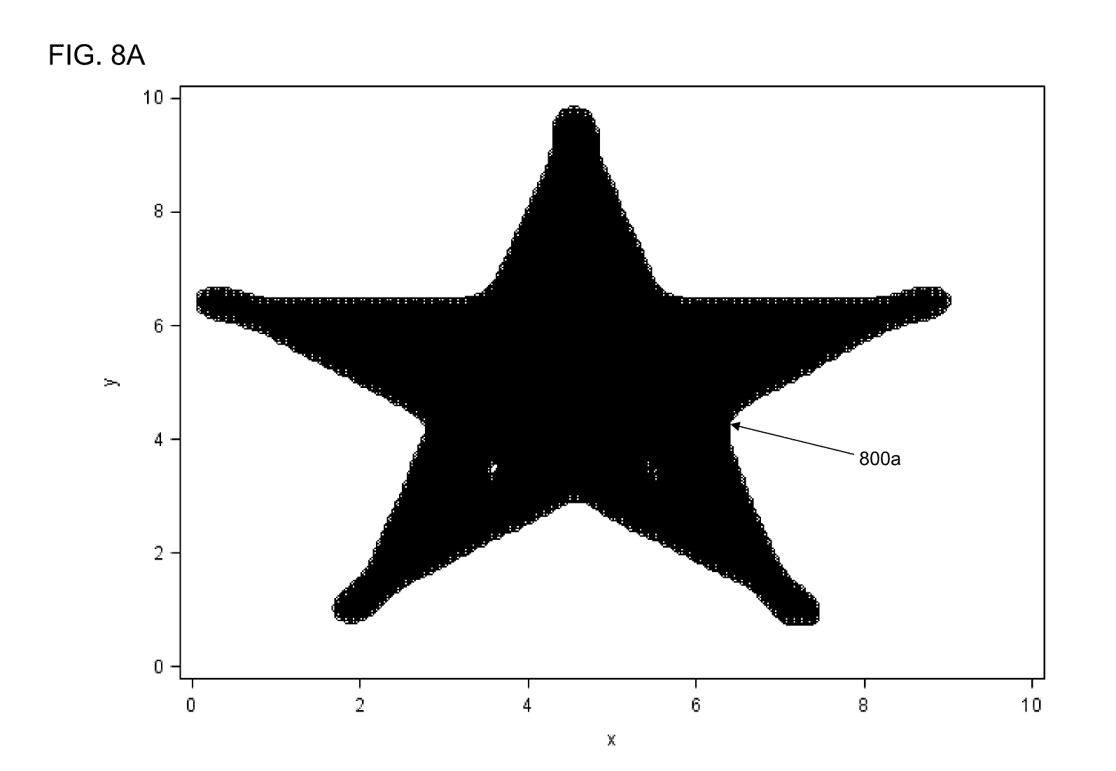

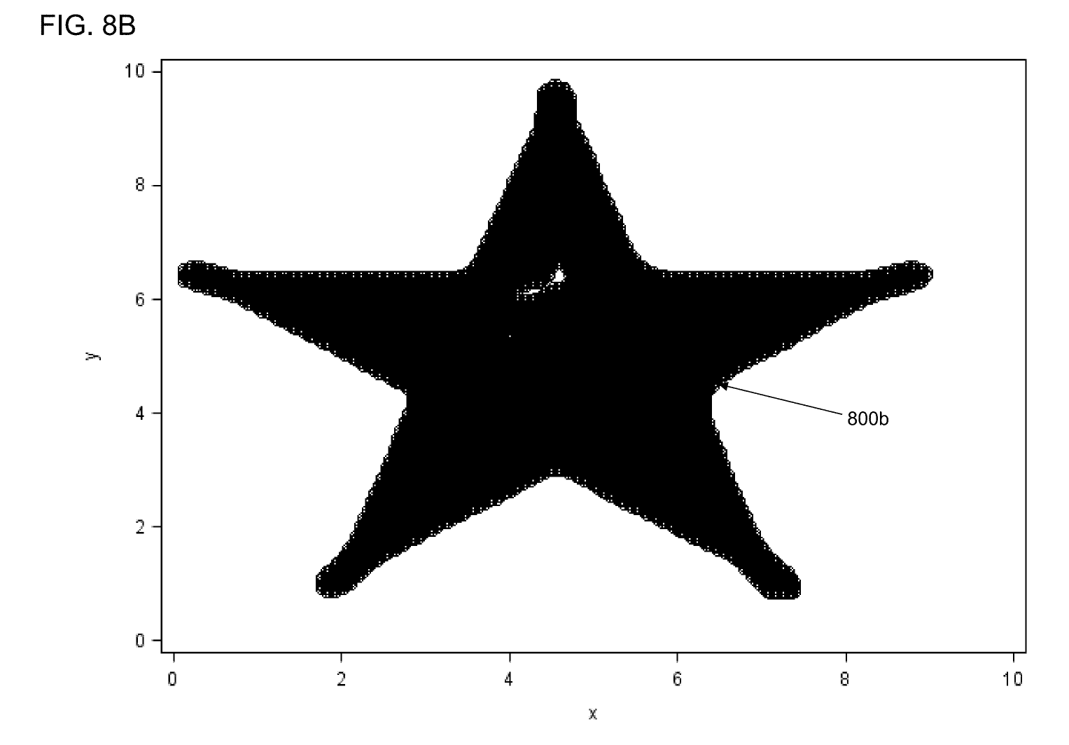

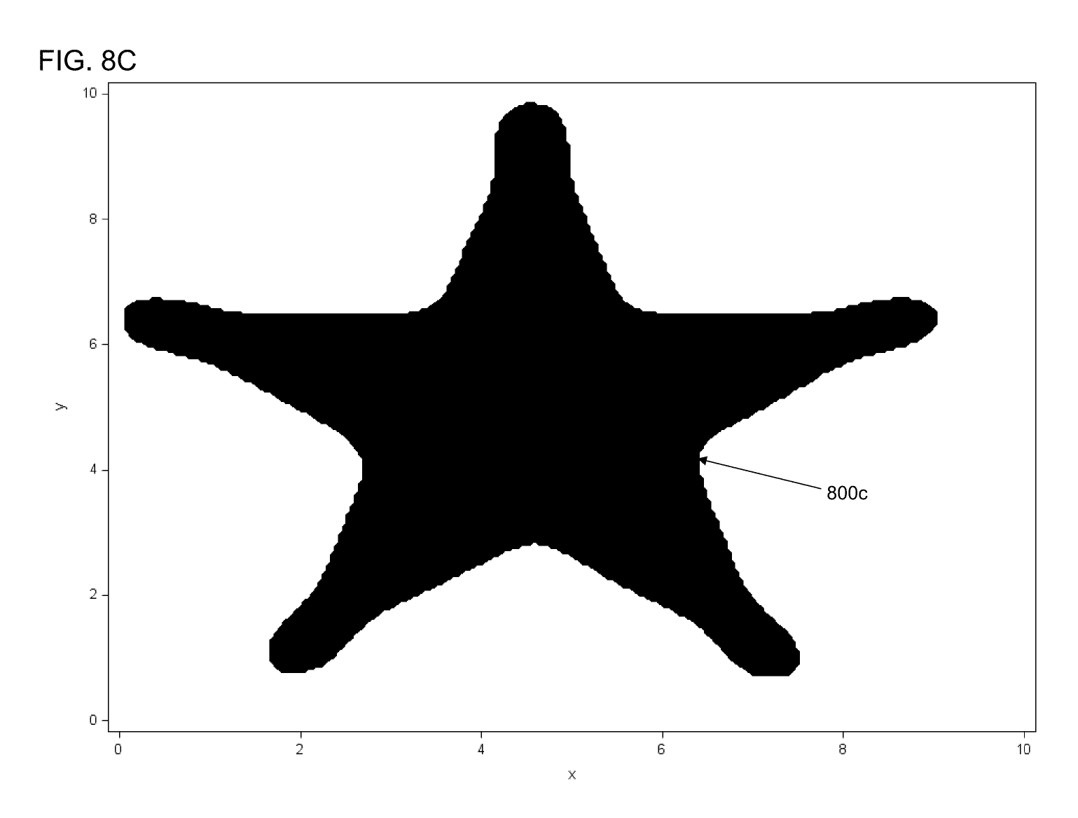

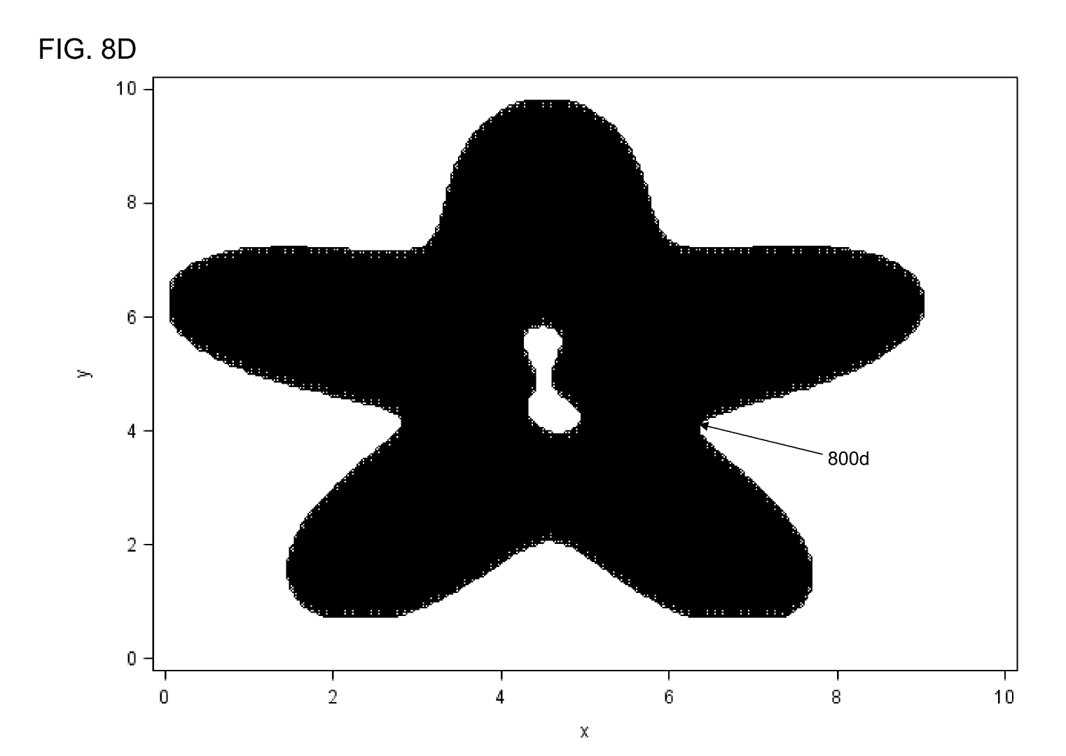

Referring to FIG. 7, a second sample dataset 700 having a star shape is shown. Referring to FIGS. 8A to 8D, scoring results from outlier identification application 1822 using the Gaussian bandwidth parameters and the associated set of support vectors SV computed using the mean criterion, the median criterion, the peak criterion, and the median₂ criterion, respectively, are shown for dataset 1824 created from second sample dataset 700.

Referring to FIG. 8A, a first dark region 800a shows observation vectors not identified as outliers with the Gaussian bandwidth parameter s=0.614647 computed using the mean criterion technique. Referring to FIG. 8B, a second dark region 800b shows observation vectors not identified as outliers with the Gaussian bandwidth parameter s=0.535809 computed using the median criterion technique. Referring to FIG. 8C, a third dark region 800c shows observation vectors not identified as outliers with the Gaussian bandwidth parameter s=0.9 computed using the peak criterion technique. Referring to FIG. 8D, a fourth dark region 800d shows observation vectors not identified as outliers with the Gaussian bandwidth parameter s=2.186423 computed using the median₂ criterion technique.

The scoring results again indicate that the Gaussian bandwidth parameter s computed using the mean and median criteria provides a good quality data description. The descriptions are close to the one obtained using the peak criterion. The median₂ criterion did not provide a quality data description.

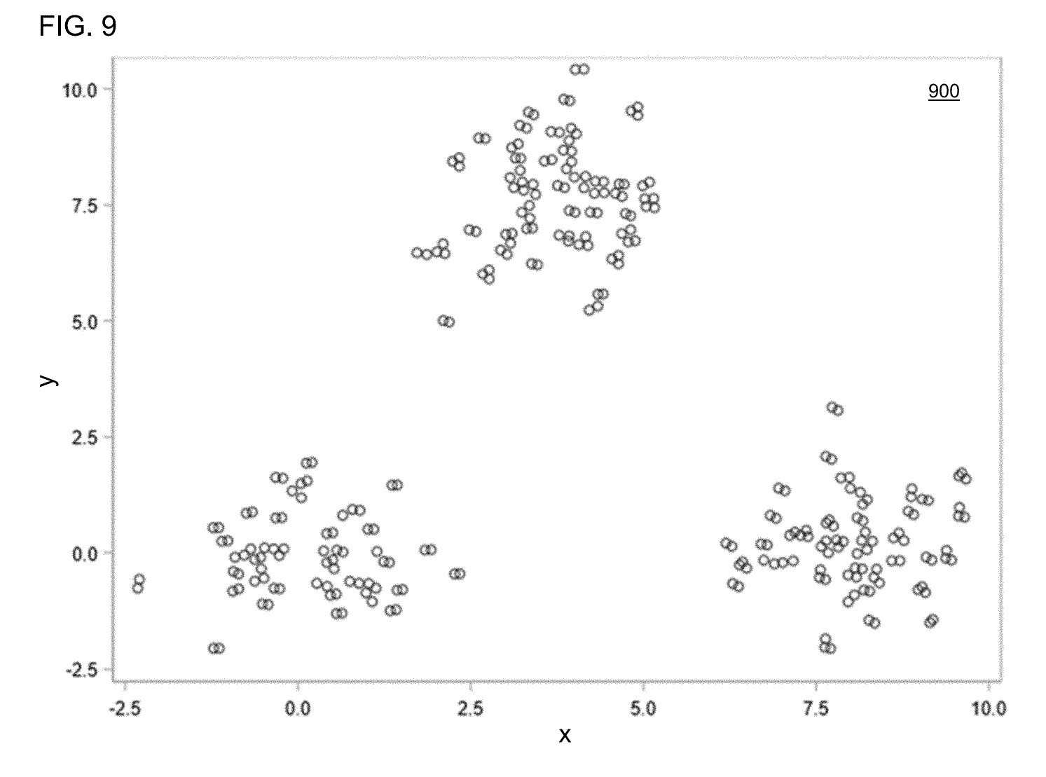

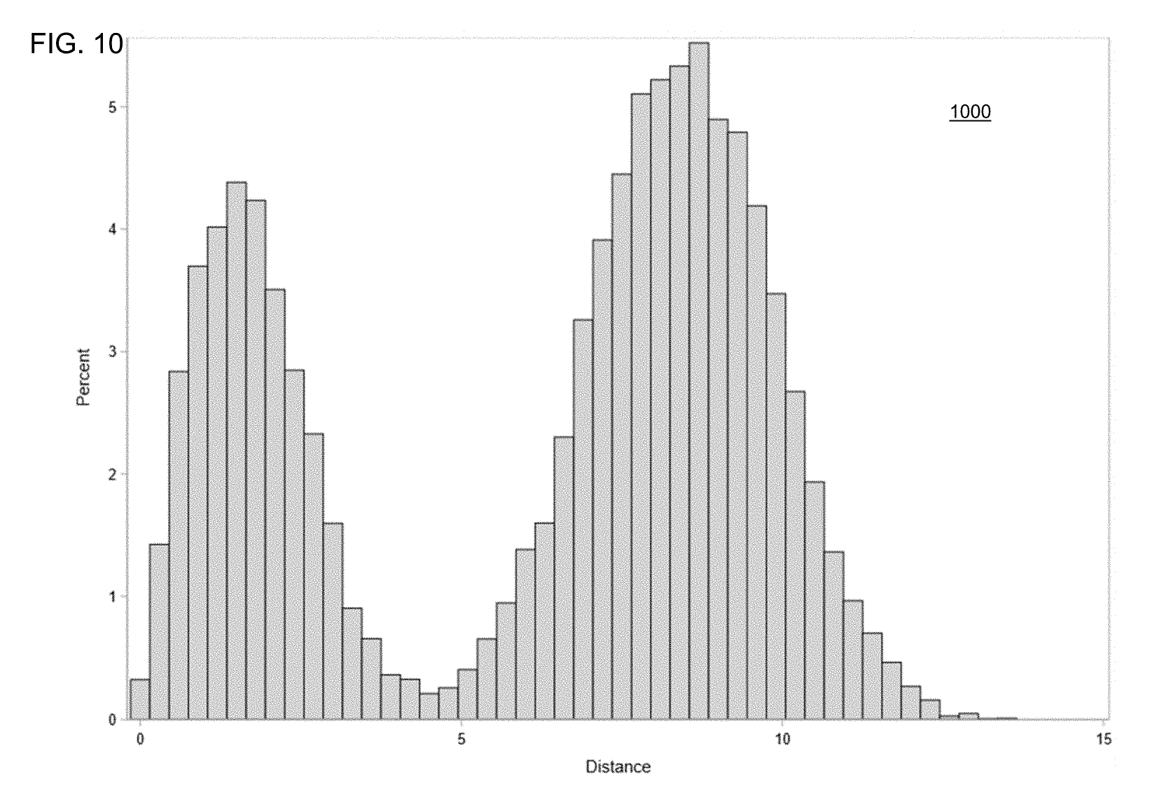

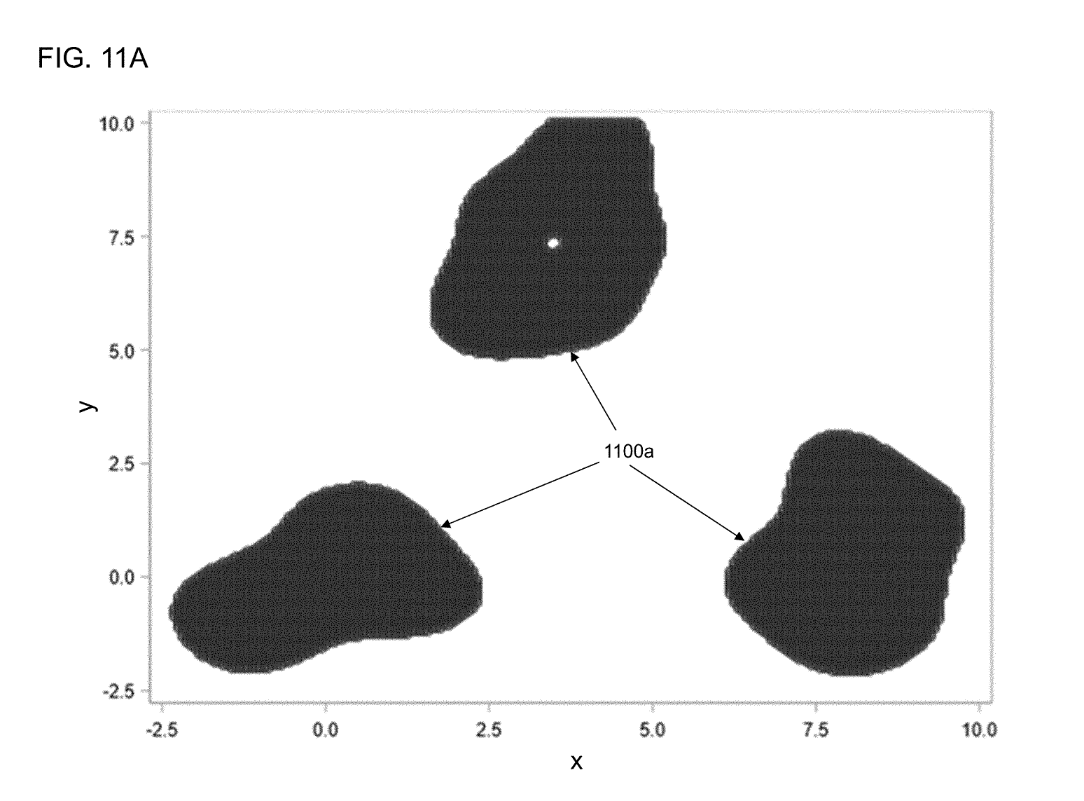

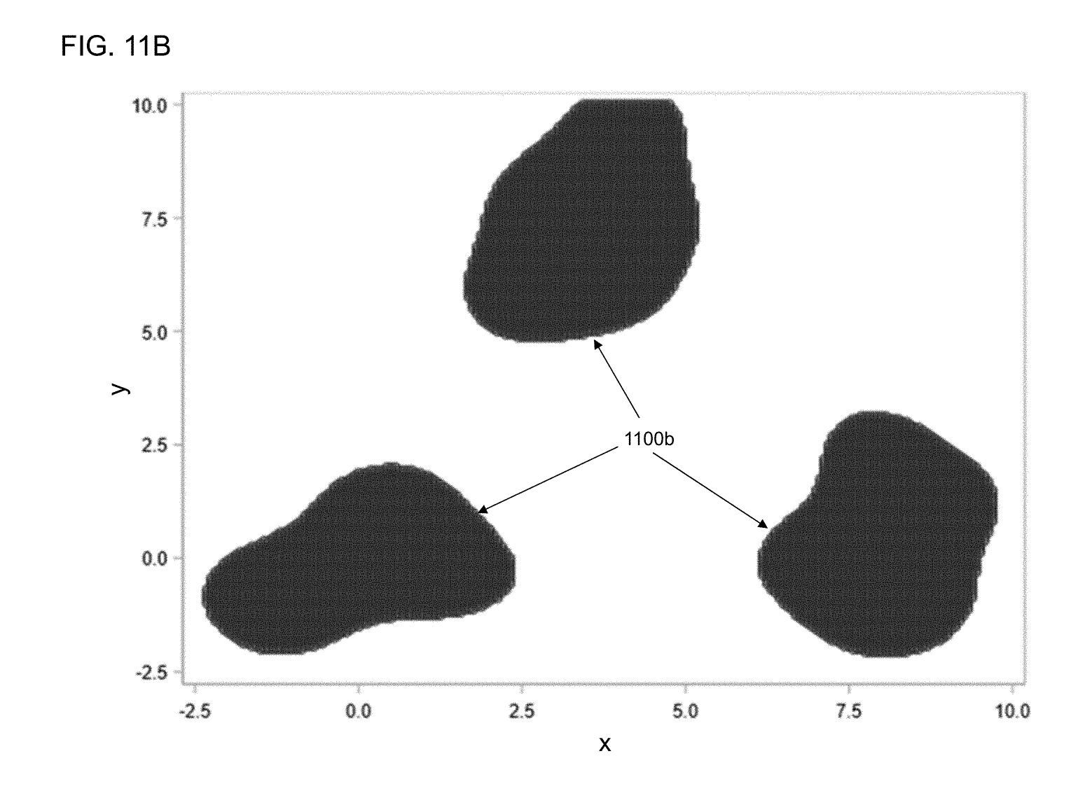

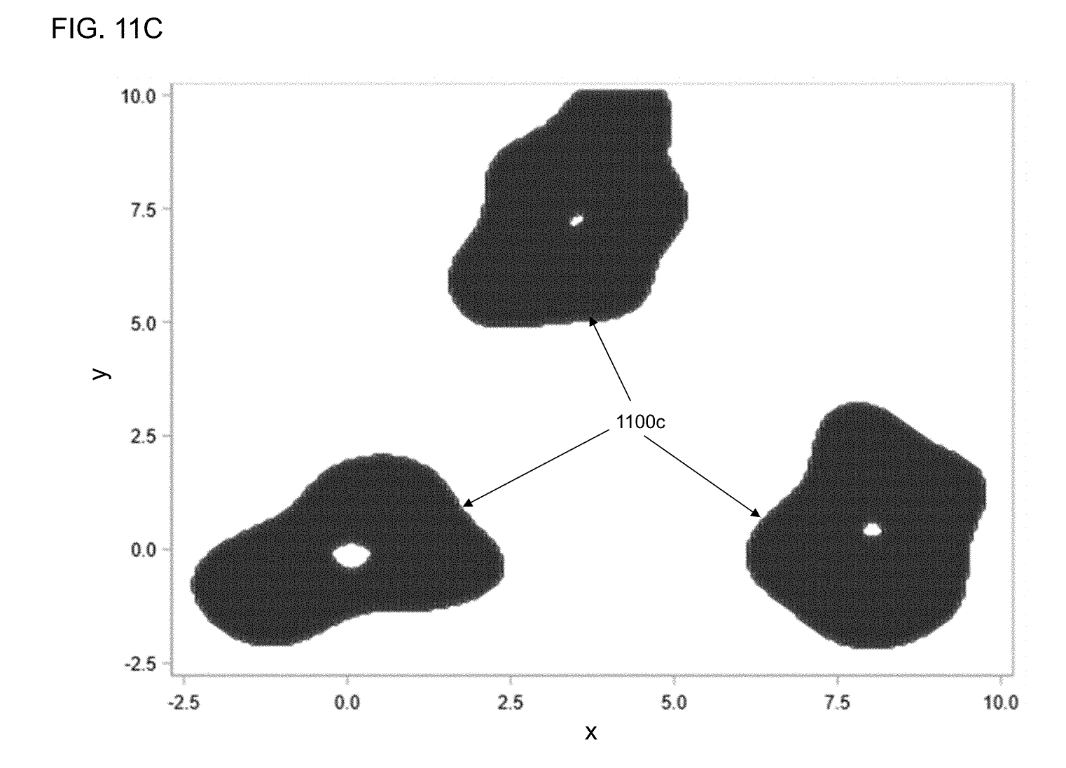

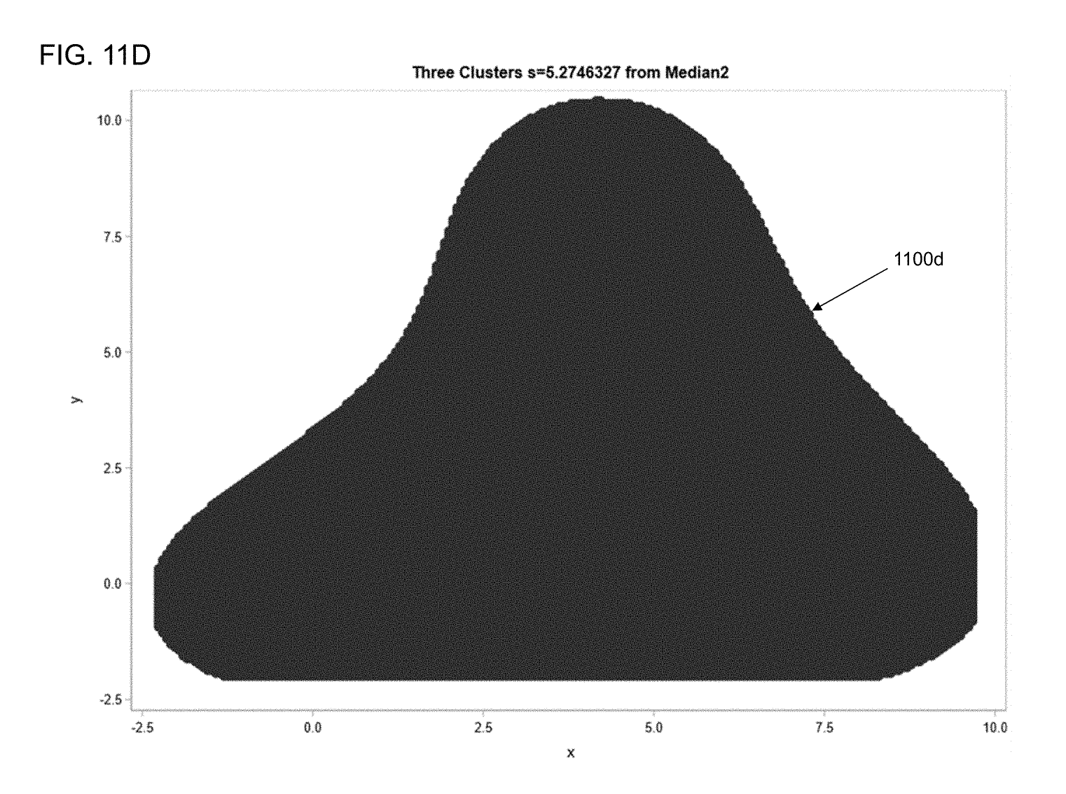

Referring to FIG. 9, a third sample dataset 900 having a three-cluster shape is shown. Referring to FIG. 10, a pairwise distance histogram 1000 of third sample dataset 900 shows that third sample dataset 900 is skewed. Referring to FIGS. 11A to 11D, scoring results from outlier identification application 1822 using the Gaussian bandwidth parameter s and the associated set of support vectors SV computed using the mean criterion, the median criterion, the peak criterion, and the median₂ criterion, respectively, are shown for dataset 1824 created from third sample dataset 900.

Referring to FIG. 11A, a first dark region 1100a shows observation vectors not identified as outliers with the Gaussian bandwidth parameter s=1.24016 computed using the mean criterion technique. Referring to FIG. 11B, a second dark region 1100b shows observation vectors not identified as outliers with the Gaussian bandwidth parameter s=1.30738 computed using the median criterion technique. Referring to FIG. 11C, a third dark region 1100c shows observation vectors not identified as outliers with the Gaussian bandwidth parameter s=1.1 computed using the peak criterion technique. Referring to FIG. 11D, a fourth dark region 1100d shows observation vectors not identified as outliers with the Gaussian bandwidth parameter s=5.2746327 computed using the median₂ criterion technique.

The scoring results again indicate that the Gaussian bandwidth parameter s computed using the mean and median criteria provides a good quality data description. The descriptions are close to the one obtained using the peak criterion. The median₂ criterion did not provide a quality data description. In fact, using the median₂ criterion the three clusters became a single cluster.

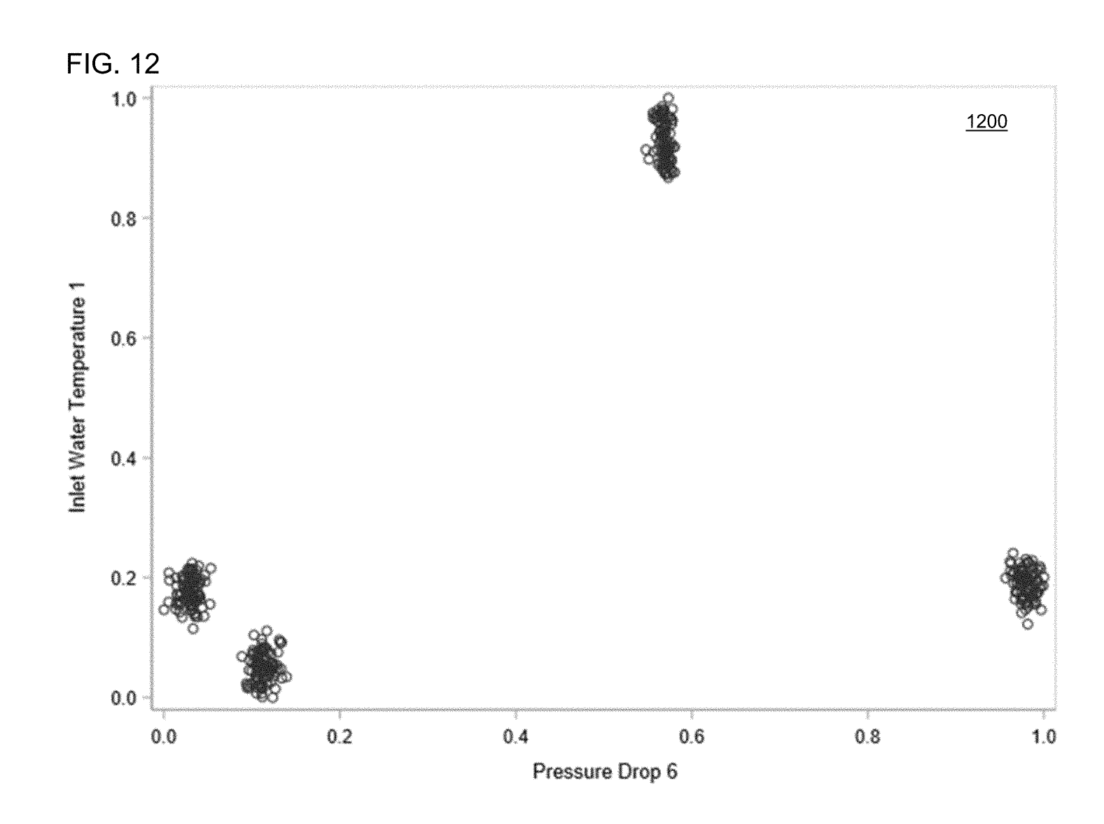

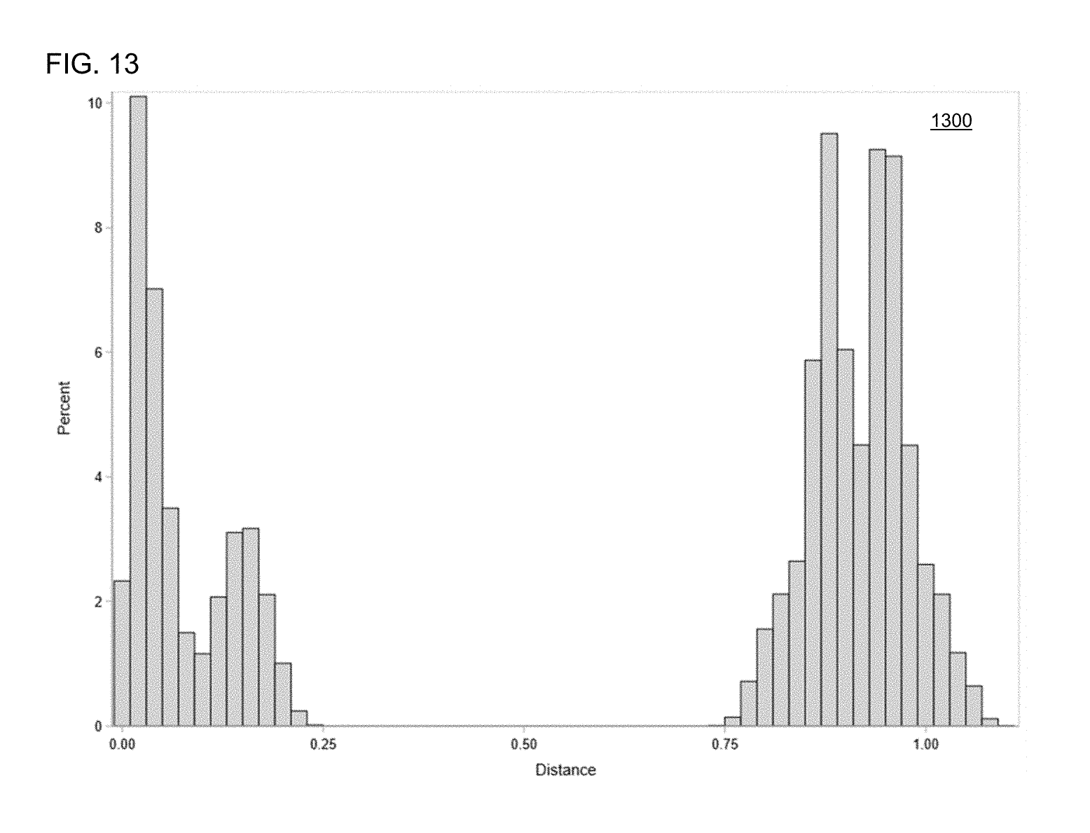

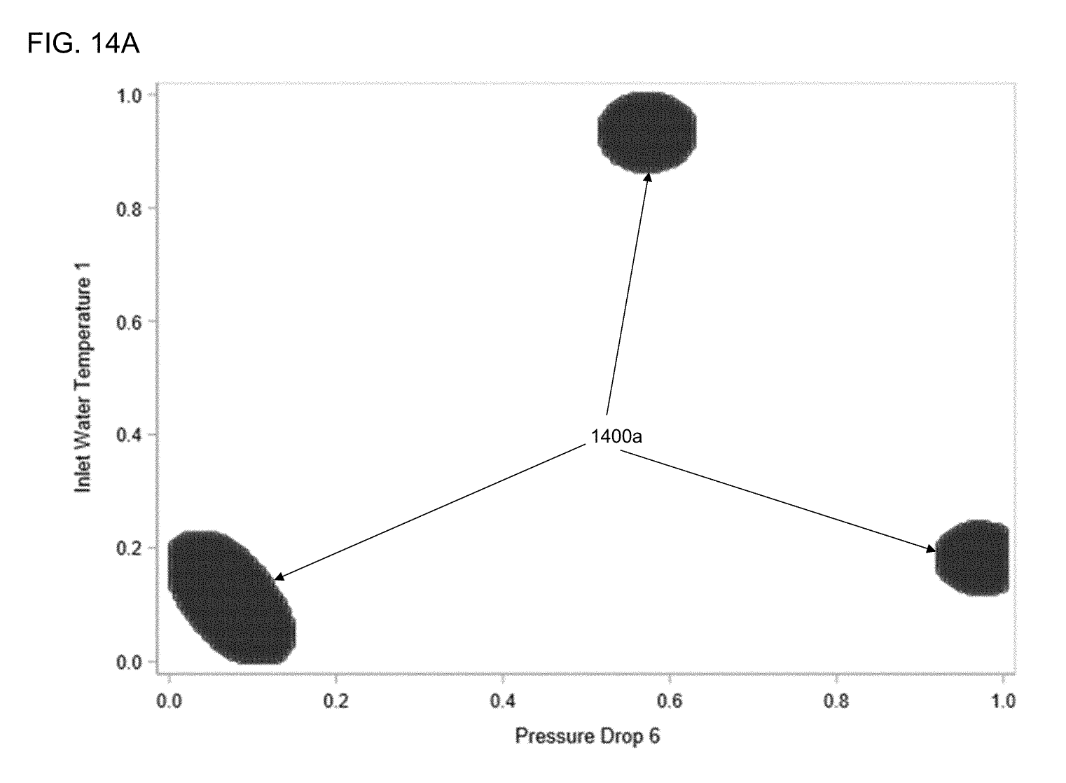

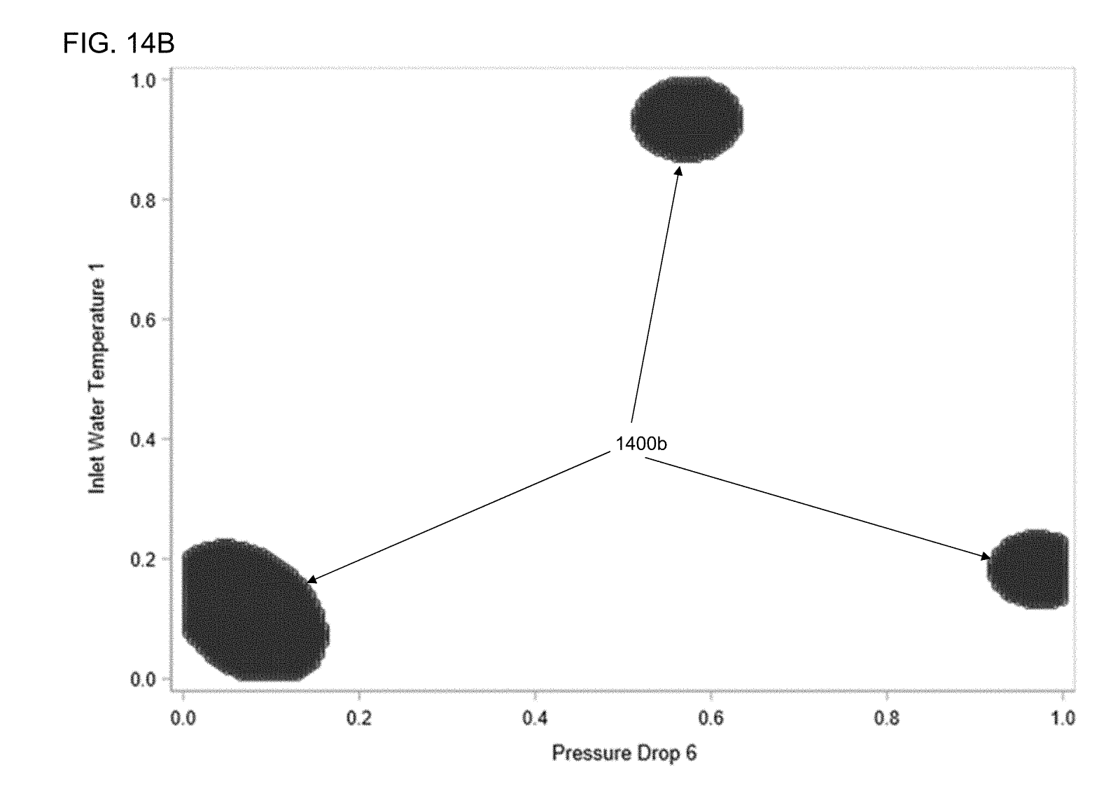

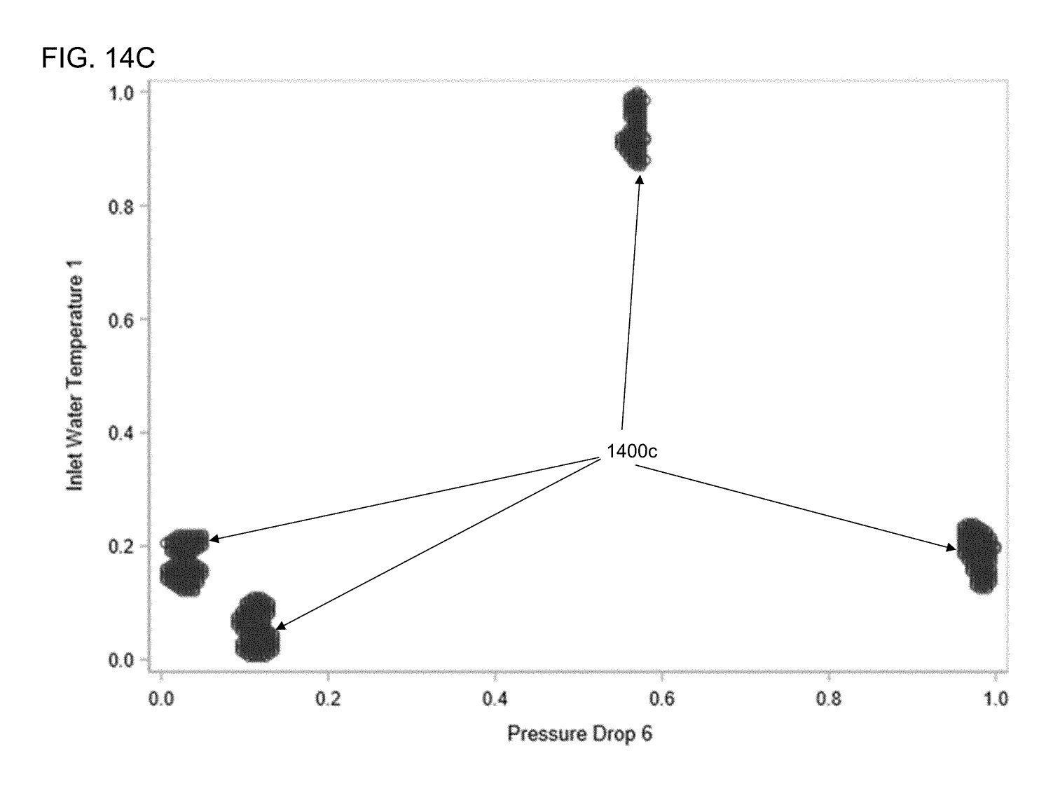

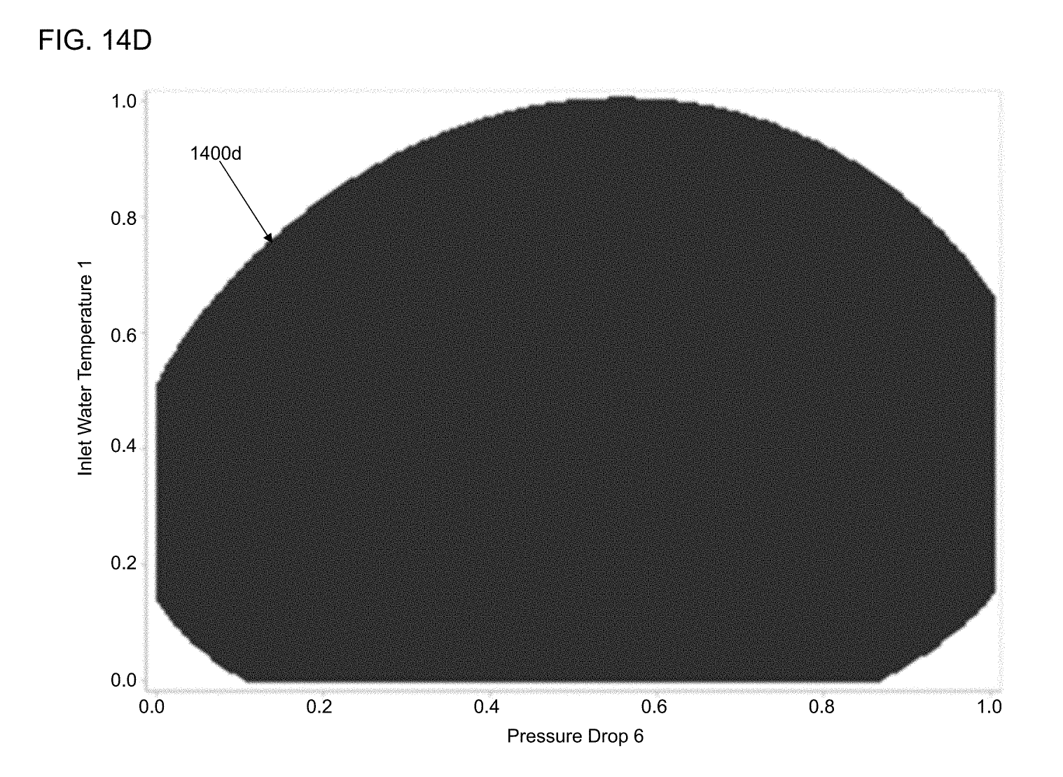

Referring to FIG. 12, a fourth sample dataset 1200 having a four-cluster shape is shown. Fourth sample dataset 1200 was created from refrigerant pressure versus inlet water temperature data that was captured. Referring to FIG. 13, a pairwise distance histogram 1300 of fourth sample dataset 1200 shows that fourth sample dataset 1200 is also skewed. Referring to FIGS. 14A to 14D, scoring results from outlier identification application 1822 using the Gaussian bandwidth parameter s and the associated set of support vectors SV computed using the mean criterion, the median criterion, the peak criterion, and the median₂ criterion, respectively, are shown for dataset 1824 created from fourth sample dataset 1200.

Referring to FIG. 14A, a first dark region 1400a shows observation vectors not identified as outliers with the Gaussian bandwidth parameter s=0.12760 computed using the mean criterion technique. Referring to FIG. 14B, a second dark region 1400b shows observation vectors not identified as outliers with the Gaussian bandwidth parameter s=0.15169 computed using the median criterion technique. Referring to FIG. 14C, a third dark region 1400c shows observation vectors not identified as outliers with the Gaussian bandwidth parameter s=0.021 computed using the peak criterion technique. Referring to FIG. 14D, a fourth dark region 1400d shows observation vectors not identified as outliers with the Gaussian bandwidth parameter s=0.6144763 computed using the median₂ criterion technique.

For fourth sample dataset 1200, the peak criterion significantly outperformed the other three techniques because the set of support vectors SV computed using the peak criterion could separate out all four of the clusters while the mean criterion and the median criterion merged the two clusters that lie close to each other in the bottom left of the graphs. Though the mean and median criterion did not perform as well as the peak criterion, any point in the inlier region was close to fourth sample dataset 1200, while the area of the region that was misclassified was small compared to the bounding region of fourth sample dataset 1200. Therefore, the result was still very reasonable. The median2 criterion again performed very poorly.

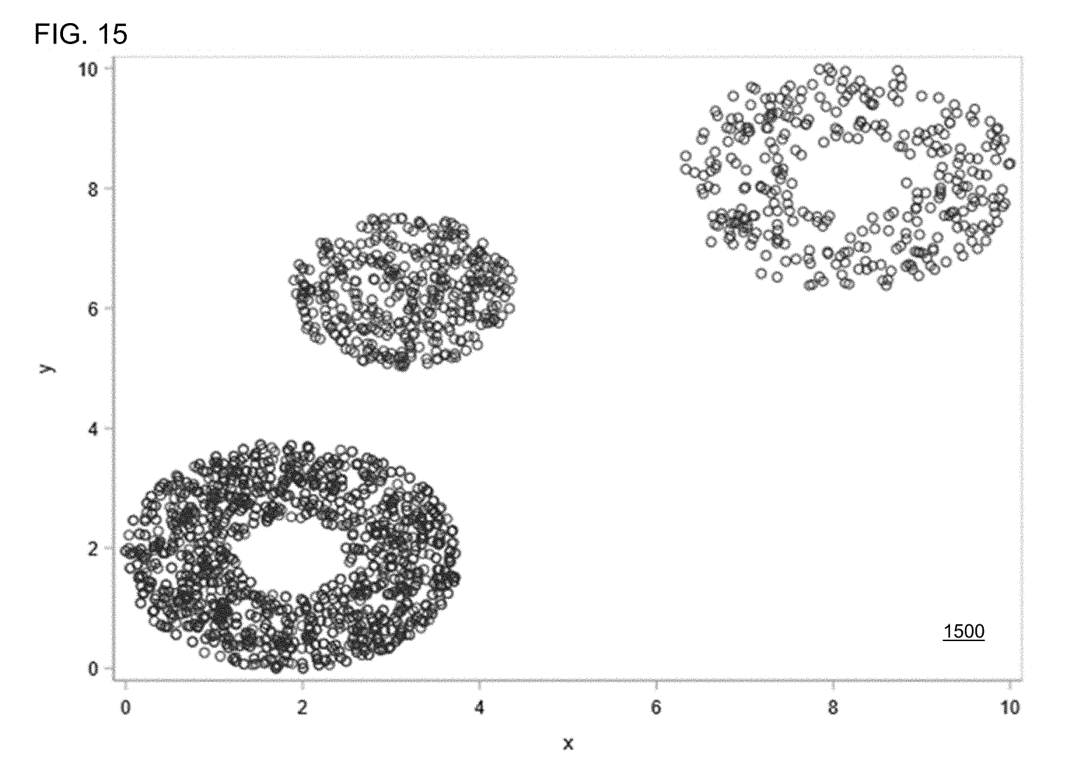

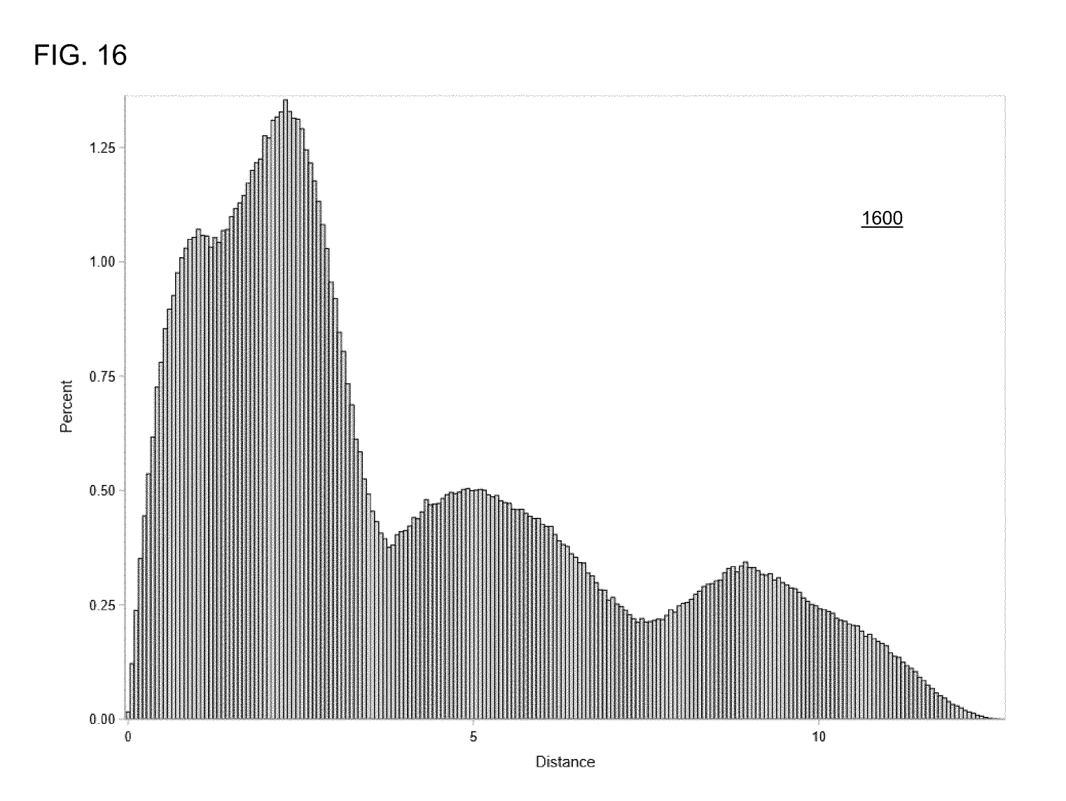

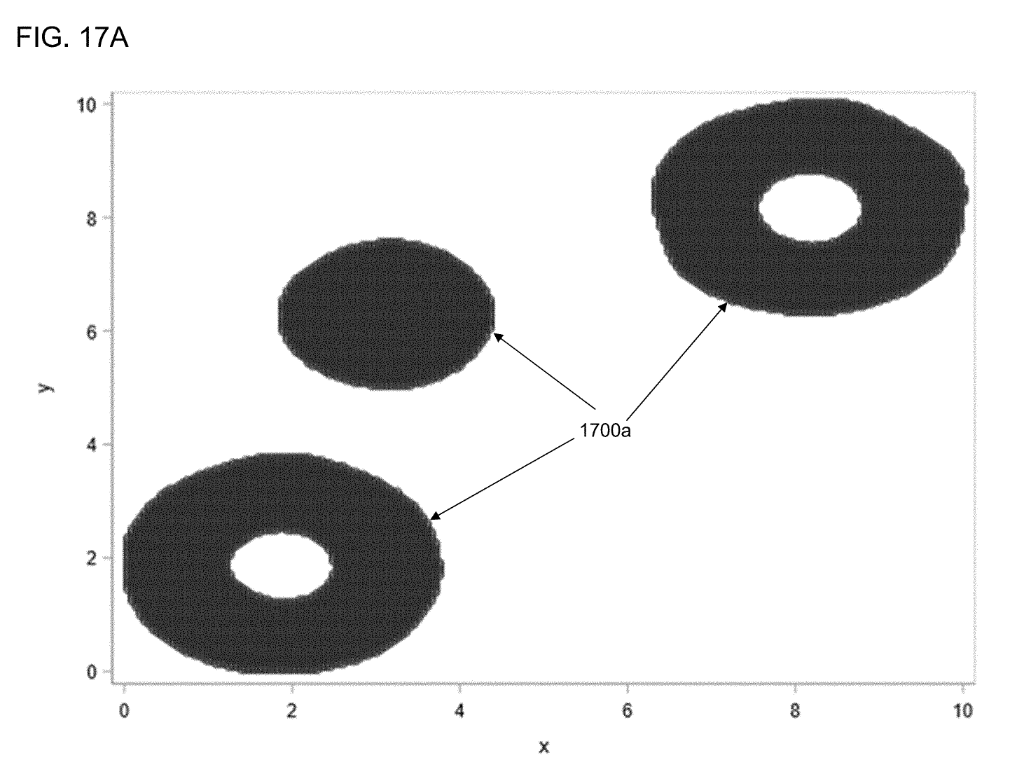

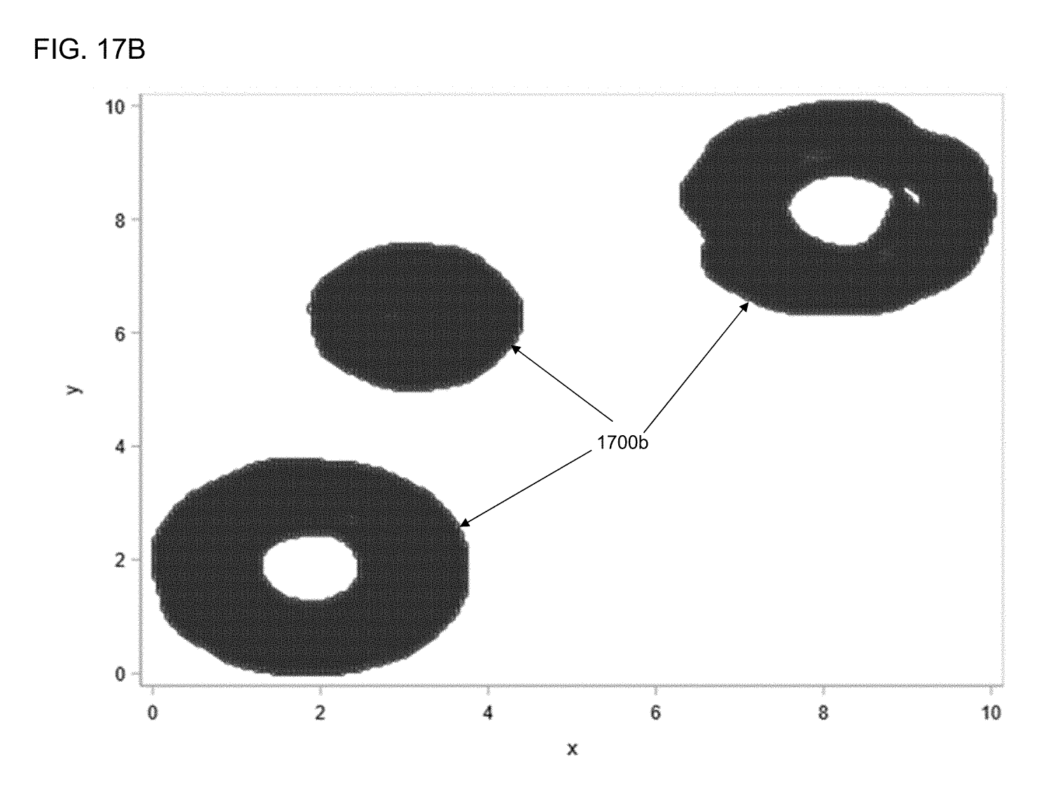

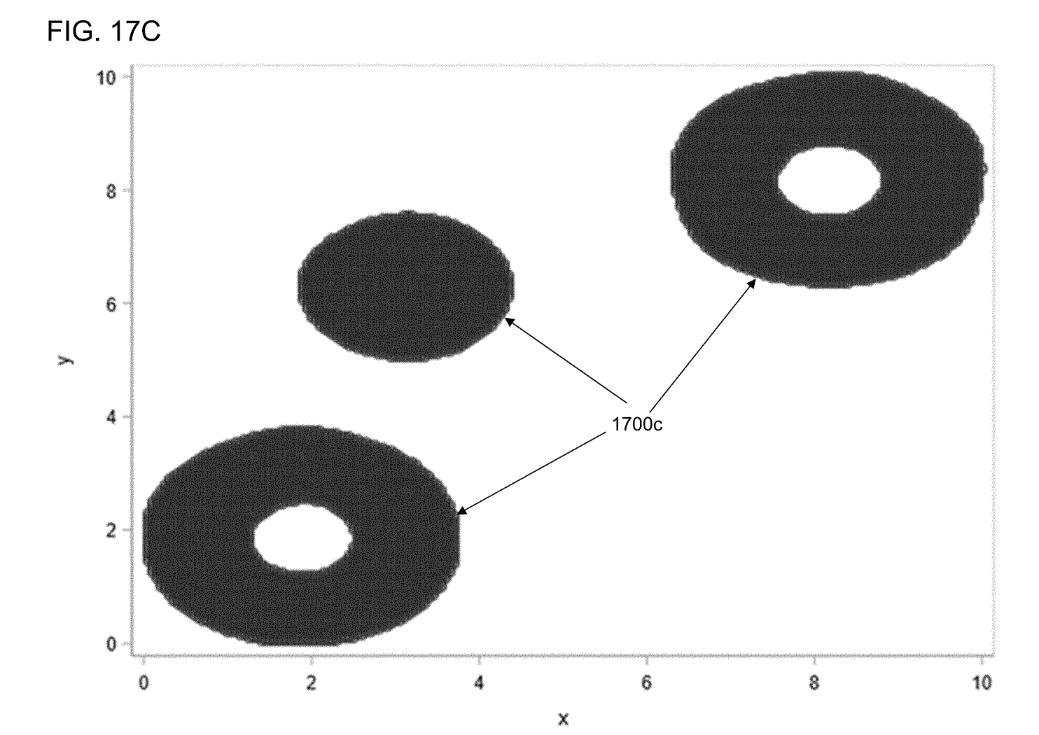

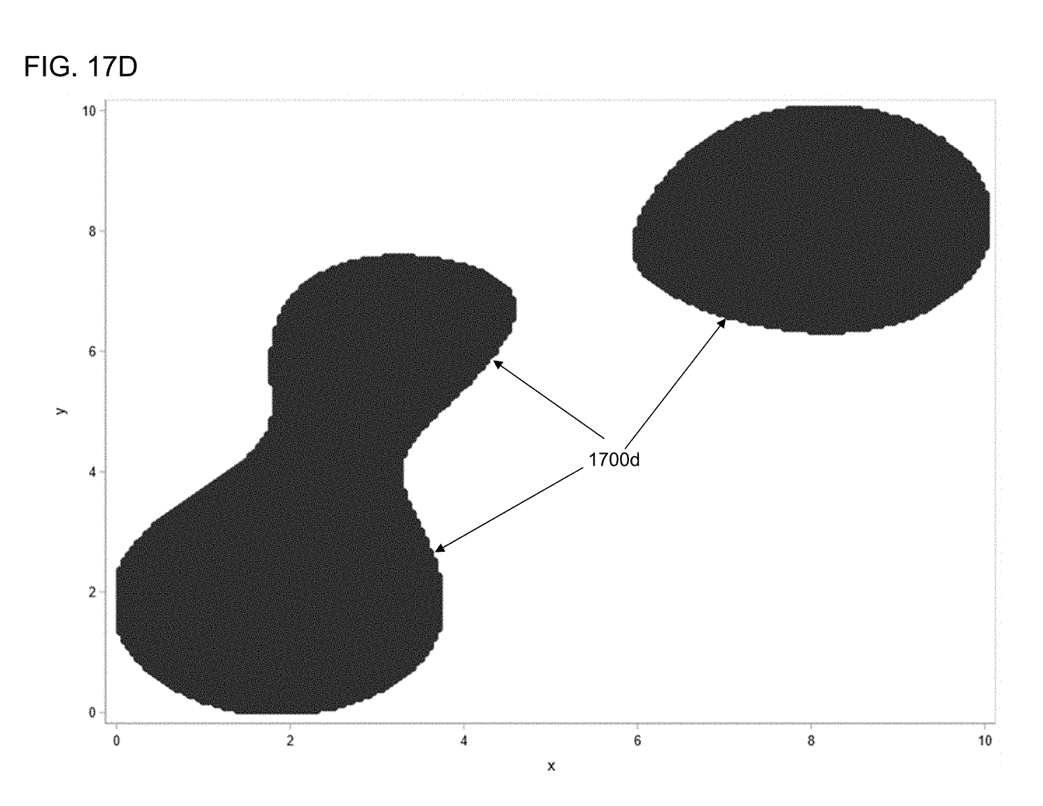

Referring to FIG. 15, a fifth sample dataset 1500 having a two-donut and a small oval shape is shown. Referring to FIG. 16, a pairwise distance histogram 1600 of fifth sample dataset 1500 shows that fifth sample dataset 1500 is also skewed. Referring to FIGS. 17A to 17D, scoring results from outlier identification application 1822 using the Gaussian bandwidth parameter s and the associated set of support vectors SV computed using the mean criterion, the median criterion, the peak criterion, and the median₂ criterion, respectively, are shown for dataset 1824 created from fifth sample dataset 1500.

Referring to FIG. 17A, a first dark region 1700a shows observation vectors not identified as outliers with the Gaussian bandwidth parameter s=0.85106 computed using the mean criterion technique. Referring to FIG. 17B, a second dark region 1700b shows observation vectors not identified as outliers with the Gaussian bandwidth parameter s=0.50064 computed using the median criterion technique. Referring to FIG. 17C, a third dark region 1700c shows observation vectors not identified as outliers with the Gaussian bandwidth parameter s=0.95 computed using the peak criterion technique. Referring to FIG. 17D, a fourth dark region 1700d shows observation vectors not identified as outliers with the Gaussian bandwidth parameter s=2.0859465 computed using the median₂ criterion technique.

For fifth sample dataset 1500, the peak criterion and the mean criterion significantly outperformed the other two techniques. The median criterion did not perform as well as the peak criterion or the mean criterion, but the result was still very reasonable. The median2 criterion again performed very poorly.

The SVDD approach requires solving a quadratic programming problem. The time needed to solve the quadratic programming problem is directly related to the size of training dataset 124. The illustrative results show that training application 122 provides a nearly identical data description using either the mean criterion or the median criterion as compared to the peak criterion.

Computation of the Gaussian bandwidth parameters using the mean criterion is extremely fast even when training dataset 124 is very large because it can be computed in a single iteration. Computation of the Gaussian bandwidth parameter S using the peak criterion requires computation of the SVDD solution multiple times using training dataset 124 for a list of bandwidth values that lie on a grid. Additionally, a good starting value for the Gaussian bandwidth parameter s is needed to initiate the grid search, and it is not immediately obvious what a good starting value is. For illustration, Table I below summarizes the computation time in seconds to calculate s using the peak criterion (sₚₑₐₖ) and s using the mean criterion (sₘₑₐₙ) with the datasets above.

TABLE I

| Dataset | sₚₑₐₖ Time | sₘₑₐₙ Time |
|---|---|---|
| First sample dataset | | |
| N = 267 | 39.77 | 1.5e−5 |
| M = 2 | | |
| Second sample dataset | | |
| N = 582 | 38.14 | 3.1e−5 |
| M = 2 | | |
| Third sample dataset | | |
| N = 276 | 39.99 | 3.1e−5 |
| M = 2 | | |
| Fourth sample dataset | | |
| N = 360 | 37.86 | 3.1e−5 |
| M = 2 | | |
| Fifth sample dataset | | |
| N = 2,400 | 43.37 | 7.8e−5 |
| M = 2 | | |

N is the number of observations in the dataset and M is the number of variables.

Table II below summarizes the computation time in seconds to calculate s using the peak criterion (sₚₑₐₖ) and s using the mean criterion (sₘₑₐₙ) with additional datasets.

TABLE II

| | Dataset | sₚₑₐₖ | sₘₑₐₙ | |
|---|---|---|---|---|
| Dataset | description | Time | Time | F-score |
| Air | Multivariate dataset from | 60.86 | 4.54e−4 | Fₚₑₐₖ = |
| Compressor | an air compressor. | | | 0.052, |
| N = 112 | Transducers are placed | | | Fₘₑₐₙ = |
| M = 254 | around the air compressor | | | 0.542 |
| | at different positions and | | | |
| | faults in the machine are | | | |
| | identified using acoustic | | | |
| | signal-based | | | |
| | diagnosisFₘₑₐₙ = | | | |
| Amine | Multivariate data from a | 46.21 | 4.37e−4 | Fₚₑₐₖ = |
| N = 1,000 | chemical manufacturing | | | 0.962, |
| M = 27 | process | | | Fₘₑₐₙ = |
| | | | | 0.962 |
| Cyber Attack | Net flow data, | 65.27 | 6.88e−4 | Fₚₑₐₖ = |
| N = 5,000 | characterizing the hourly | | | 0.989, |
| M = 7 | network traffic in an | | | Fₘₑₐₙ = |
| | organization, collected for | | | 0.977 |
| | each IP address | | | |
| Low Density | Data from a low-density | 74.45 | 1.6e−5 | Fₚₑₐₖ = |
| Polyethylene | polyethylene production | | | 0.61, |
| N = 25 | process | | | Fₘₑₐₙ = |
| M = 19 | | | | 0.485 |
| Metal | 20 process variables, an id | 35.91 | 1.5e−5 | Fₚₑₐₖ = |
| N = 96 | variable, and a time stamp | | | 0.588, |
| M = 8 | variable from a metal | | | Fₘₑₐₙ = |
| | wafer etcher | | | 0.429 |
| Shuttle | Nine numeric attributes | 48.17 | 3.44e−4 | Fₚₑₐₖ = |
| N = 2,000 | and one class attribute | | | 0.96, |
| M = 9 | that identify state changes | | | Fₘₑₐₙ = |
| | of the shuttle | | | 0.95 |
| Spam | E-mails either classified as | 50.05 | 1.33e−3 | Fₚₑₐₖ = |
| N = 1,500 | spam or not | | | 0.626, |
| M = 57 | | | | Fₘₑₐₙ = |
| | | | | 0.626 |
| Tennessee | Simulation data generated | 39.02 | 1.25e−4 | Fₚₑₐₖ = |
| Eastman | from a model of an | | | 0.16, |
| N = 200 | industrial chemical | | | Fₘₑₐₙ = |
| M = 41 | process | | | 0.15 |

Fₚₑₐₖ is an F-score computed for s using the peak criterion (sₚₑₐₖ) and Fₘₑₐₙ is an F-score computed for s using the mean criterion (sₘₑₐₙ) where the F-score can be defined as

$${F}_{score} = 2 * \frac{precision * recall}{precision + recall} , where precision = \frac{tp}{tp + fp} and$$

$$recall = \frac{tp}{tp + fn} ,$$

where tp is a number of true positives, fp is a number of false positives, and fn is a number of false negatives. The results show the extreme improvement in computation time with a nearly identical data description that results from use of sₘₑₐₙ Therefore, use of sₘₑₐₙ provides a significant improvement over prior methods.

Computation of the Gaussian bandwidth parameters using the mean criterion is extremely fast even when training dataset 124 is very large because it can be computed in a single iteration.

Training application 122 can be implemented as a wrapper code around a core module for SVDD training computations either in a single machine or in a multi-machine distributed environment. There are applications for training application 122 and outlier identification application 1822 in areas such as process control and equipment health monitoring where the size of training dataset 124 can be very large, consisting of a few million observations. Training dataset 124 may include sensor readings measuring multiple key health or process parameters at a very high frequency. For example, a typical airplane currently has ^{˜}7,000 sensors measuring critical health parameters and creates 2.5 terabytes of data per day. By 2020, this number is expected to triple or quadruple to over 7.5 terabytes. In such applications, multiple SVDD training models may be developed with each representing a different operating mode of the equipment or different process settings. Successful application of a SVDD in these types of applications requires algorithms that can train using huge amounts of training data in an efficient manner, which is provided by training application 122 in particular using the mean criterion.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”. Still further, using “and” or “or” in the detailed description is intended to include “and/or” unless specifically indicated otherwise.

The foregoing description of illustrative embodiments of the disclosed subject matter has been presented for purposes of illustration and of description. It is not intended to be exhaustive or to limit the disclosed subject matter to the precise form disclosed, and modifications and variations are possible in light of the above teachings or may be acquired from practice of the disclosed subject matter. The embodiments were chosen and described in order to explain the principles of the disclosed subject matter and as practical applications of the disclosed subject matter to enable one skilled in the art to utilize the disclosed subject matter in various embodiments and with various modifications as suited to the particular use contemplated.

1. A non-transitory computer-readable medium having stored thereon computer-readable instructions that when executed by a computing device cause the computing device to:
compute a mean pairwise distance value between a plurality of observation vectors, wherein each observation vector of the plurality of observation vectors includes a variable value for each variable of a plurality of variables, wherein the mean pairwise distance value is computed using
$${\overline{D}}^{2} = \frac{2 N}{( N - 1 )} {\sum }_{j = 1}^{p} {σ}_{j}^{2} ,$$
, where D̅ is the mean pairwise distance value, N is a number of the plurality of observation vectors, p is a number of the plurality of variables, and σⱼ² is a variance of each variable of the plurality of variables;
compute a scaling factor value based on a number of the plurality of observation vectors and a predefined tolerance value;
compute a Gaussian bandwidth parameter value using the computed mean pairwise distance value and the computed scaling factor value;
compute an optimal value of an objective function that includes a Gaussian kernel function that uses the computed Gaussian bandwidth parameter value, wherein the objective function defines a support vector data description (SVDD) model using the plurality of observation vectors to define a set of support vectors and a set of Lagrange constants, wherein a Lagrange constant is defined for each support vector of the defined set of support vectors;
output the computed Gaussian bandwidth parameter value, the defined set of support vectors, and the set of Lagrange constants;
receive a new observation vector;
compute a distance value using the defined set of support vectors, the defined set of Lagrange constants, and the received new observation vector; and
when the computed distance value is greater than a computed threshold, identify the received new observation vector as an outlier.

2. The non-transitory computer-readable medium of claim 1, wherein the σⱼ² is a weighted variance of each variable of the plurality of variables.

3. The non-transitory computer-readable medium of claim 1, wherein the variance for a first variable of the plurality of variables is computed using
$${σ}_{1}^{2} = \frac{{\sum }_{i = 1}^{N} {( {x}_{i 1} - {μ}_{1} )}^{2}}{N} , where {μ}_{1} = \frac{{\sum }_{i = 1}^{N} {x}_{i 1}}{N}$$
is a mean value computed from each observation vector value of the plurality of observation vectors for the first variable, and xᵢ₁ is a value for the first variable of the ith observation vector of the plurality of observation vectors.

4. The non-transitory computer-readable medium of claim 1, wherein the scaling factor value is computed using F=1/\sqrt{ln[(N−1)/δ²]}, where F is the scaling factor value, N is the number of the plurality of observation vectors, and δ is the predefined tolerance value.

5. The non-transitory computer-readable medium of claim 4, wherein the predefined tolerance value is selected between \sqrt{2}×10⁻⁷≤δ≤\sqrt{2}×10⁻⁵.

6. The non-transitory computer-readable medium of claim 1, wherein the Gaussian bandwidth parameter value is computed by multiplying the mean pairwise distance value with the scaling factor value.

7. The non-transitory computer-readable medium of claim 1, wherein the Gaussian bandwidth parameter value is computed using s=D̅F, where s is the Gaussian bandwidth parameter value and F is the scaling factor value.

8. The non-transitory computer-readable medium of claim 7, wherein the scaling factor value is computed using F=1/\sqrt{ln[(N−1)/δ²]}, where δ is the predefined tolerance value.

9. The non-transitory computer-readable medium of claim 1, wherein the scaling factor value is computed using F=W/\sqrt{Q×ln[2Q/(δ²M)]}, where F is the scaling factor value, W=Σᵢ₌₁^{N1}wᵢ, M=Σᵢ₌₁^{N1}wᵢ², Q=(W²−M)/2, N1 is a number of distinct observation vectors included in the plurality of observation vectors, δ is the predefined tolerance value, and wᵢ is a repetition vector that indicates a number of times each observation vector of the distinct observation vectors is repeated.

10. The non-transitory computer-readable medium of claim 9, wherein the σⱼ² is a weighted variance of each variable of the plurality of variables.

11. The non-transitory computer-readable medium of claim 10, wherein the weighted variance for a first variable of the plurality of variables is computed using
$${σ}_{1}^{2} = \frac{{\sum }_{i = 1}^{{N}_{1}} {{w}_{i} ( {x}_{{i}_{1}} - {μ}_{1} )}^{2}}{W} ,$$
, where
$${μ}_{1} = \frac{{\sum }_{i = 1}^{{N}_{1}} {w}_{i} {x}_{i 1}}{w}$$
is a mean value computed from each observation vector value of the distinct observation vectors for the first variable, and xᵢ₁ is a value for the first variable of the ith observation vector of the distinct observation vectors.

12. The non-transitory computer-readable medium of claim 10, wherein the Gaussian bandwidth parameter value is computed using s=σF, where s is the Gaussian bandwidth parameter value, σ²=Σᵢ₌₁^{p}σᵢ², and F is the scaling factor value.

13. The non-transitory computer-readable medium of claim 1, wherein the objective function defined for the SVDD model is max(Σᵢ₌₁^{N}αᵢK(xᵢ,xᵢ)−Σᵢ₌₁^{N}Σⱼ₌₁^{N}αᵢαⱼK(xᵢ,xⱼ)), subject to Σᵢ₌₁^{N}αᵢ=1 and 0≤αᵢ≤C, ∀i=1, . . . , N, where K(xᵢ,xⱼ) is the Gaussian kernel function, N is the number of the plurality of observation vectors, C=1/Nf, where f is an expected outlier fraction, xᵢ and xⱼ are ith and jth observation vectors of the plurality of observation vectors, respectively, and αᵢ and αⱼ are ith and jth Lagrange constants of the set of Lagrange constants, respectively.

14. The non-transitory computer-readable medium of claim 13, wherein the xᵢ that have 0<αᵢ≤C are the defined set of support vectors.

15. The non-transitory computer-readable medium of claim 1, wherein
the new observation vector is received by reading the new observation vector from a dataset.

16. The non-transitory computer-readable medium of claim 14, wherein the threshold is computed using R²=K(xₖ,xₖ)−2Σᵢ₌₁^{NSV}αᵢK(xᵢ,xₖ)+Σᵢ₌₁^{NSV}Σⱼ₌₁^{NSV}αᵢαⱼK(xᵢ,xⱼ), where xₖ is any support vector of the defined set of support vectors, and NSV is a number of support vectors included in the defined set of support vectors.

17. The non-transitory computer-readable medium of claim 16, wherein the computer-readable instructions further cause the computing device to output the computed threshold.

18. The non-transitory computer-readable medium of claim 16, wherein the distance value is computed using dist²(z)=K(z,z)−2Σᵢ₌₁^{NSV}αᵢK(xᵢ,z)+Σᵢ₌₁^{NSV}Σⱼ₌₁^{NSV}αᵢαⱼK(xᵢ,xⱼ), where z is the received new observation vector.

19. The non-transitory computer-readable medium of claim 1, wherein when the computed distance value is not greater than the computed threshold, the received new observation vector is not identified as an outlier.

20. The non-transitory computer-readable medium of claim 1, wherein
each variable of the plurality of variables describes a characteristic of a physical object.

21. A computing device comprising:
a processor; and
a non-transitory computer-readable medium operably coupled to the processor, the computer-readable medium having computer-readable instructions stored thereon that, when executed by the processor, cause the computing device to
compute a mean pairwise distance value between a plurality of observation vectors, wherein each observation vector of the plurality of observation vectors includes a variable value for each variable of a plurality of variables, wherein the mean pairwise distance value is computed using
$${μ}_{1} = \frac{{\sum }_{i = 1}^{{N}_{1}} {w}_{i} {x}_{{i}_{1}}}{W}$$
, where D̅ is the mean pairwise distance value, N is a number of the plurality of observation vectors, p is a number of the plurality of variables, and σⱼ² is a variance of each variable of the plurality of variables;
compute a scaling factor value based on a number of the plurality of observation vectors and a predefined tolerance value;
compute a Gaussian bandwidth parameter value using the computed mean pairwise distance value and the computed scaling factor value;
compute an optimal value of an objective function that includes a Gaussian kernel function that uses the computed Gaussian bandwidth parameter value, wherein the objective function defines a support vector data description (SVDD) model using the plurality of observation vectors to define a set of support vectors; and
output the computed Gaussian bandwidth parameter value and the defined set of support vectors for determining if a new observation vector is an outlier.

22. A method of determining a bandwidth parameter value for a support vector data description for outlier identification, the method comprising:
computing, by a computing device, a mean pairwise distance value between a plurality of observation vectors, wherein each observation vector of the plurality of observation vectors includes a variable value for each variable of a plurality of variables, wherein the mean pairwise distance value is computed using
$${μ}_{1} = \frac{{\sum }_{i = 1}^{{N}_{1}} {w}_{i} {x}_{{i}_{1}}}{W}$$
, where D̅ is the mean pairwise distance value, N is a number of the plurality of observation vectors, p is a number of the plurality of variables, and σⱼ² is a variance of each variable of the plurality of variables;
computing, by the computing device, a scaling factor value based on a number of the plurality of observation vectors and a predefined tolerance value;
computing, by the computing device, a Gaussian bandwidth parameter value using the computed mean pairwise distance value and the computed scaling factor value;
computing, by the computing device, an optimal value of an objective function that includes a Gaussian kernel function that uses the computed Gaussian bandwidth parameter value, wherein the objective function defines a support vector data description (SVDD) model using the plurality of observation vectors to define a set of support vectors; and
outputting, by the computing device, the computed Gaussian bandwidth parameter value and the defined set of support vectors for determining if a new observation vector is an outlier.

23. The method of claim 22, wherein the σⱼ² is a weighted variance of each variable of the plurality of variables.

24. The method of claim 22, wherein the variance for a first variable of the plurality of variables is computed using
$${σ}_{1}^{2} = \frac{{\sum }_{i = 1}^{N} {( {x}_{i 1} - {μ}_{1} )}^{2}}{N} , where {μ}_{1} = \frac{{\sum }_{i = 1}^{N} {x}_{i 1}}{N}$$
is a mean value computed from each observation vector value of the plurality of observation vectors for the first variable, and xᵢ₁ is a value for the first variable of the ith observation vector of the plurality of observation vectors.

25. The method of claim 22, wherein the scaling factor value is computed using F=1/\sqrt{ln[(N−1)/δ²]}, where F is the scaling factor value, N is the number of the plurality of observation vectors, and δ is the predefined tolerance value.

26. The method of claim 25, wherein the predefined tolerance value is selected between \sqrt{2}×10⁻⁷≤δ≤\sqrt{2}×10⁻⁵.

27. The method of claim 22, wherein the Gaussian bandwidth parameter value is computed by multiplying the mean pairwise distance value with the scaling factor value.

28. The method of claim 22, wherein the Gaussian bandwidth parameter value is computed using s=D̅F, where s is the Gaussian bandwidth parameter value and F is the scaling factor value.

29. The method of claim 28, wherein the scaling factor value is computed using F=1/\sqrt{ln[(N−1)/δ²]}, where δ is the predefined tolerance value.

30. The method of claim 22, wherein the scaling factor value is computed using F=W/\sqrt{Q×ln[2Q/(δ²M)]}, where F is the scaling factor value, W=Σᵢ₌₁^{N1}wᵢ, M=Σᵢ₌₁^{N1}wᵢ², Q=(W²−M)/2, N1 is a number of distinct observation vectors included in the plurality of observation vectors, δ is the predefined tolerance value, and wᵢ is a repetition vector that indicates a number of times each observation vector of the distinct observation vectors is repeated.
